(19) United States
(12) Patent Application Publication
(10) Pub. No.: US 2003/0229550 A1
(43) Pub. Date: Dec. 11, 2003

(54) System and method for planning and ordering components for a configure-to-order manufacturing process

(75) Inventors: Joseph Alfred DiPrima, Raleigh, NC (US); Thomas Albert Kelly, Longmont, CO (US); Amanda Joyce Kotecki, Hillsborough, NC (US); Shirley Mary McKenna, Raleigh, NC (US)

Correspondence Address: IBM Corporation, Personal and printing Systems Group Legal Dept., Dept. 9CCA/Bldg. 002-2, P.O. Box 12195, Research Triangle Park, NC, 27709, US

(73) Assignee: International Business Machines Corporation, Armonk, NY (US)

(21) Appl. No.: 10/165,163

(22) Filed: Jun. 7, 2002

(51) Int. Cl. G06F 17/60

(52) U.S. Cl. 705/28

(57) ABSTRACT

A computer-implemented method for planning and implementing the ordering of component parts provides for inputs customers ordering products and from suppliers, indicating whether they can supply component parts to meet net demand levels during specified time periods. The planning method is performed on an ongoing basis, such as on a weekly basis with data being prepared for the current week and for the next twelve weeks. The method is particularly adapted to be used for a number of fixed configuration products and additionally for a number of configure-to-order products, the configuration of which is specified in customer orders.

### BACKGROUND OF THE INVENTION

1. Field of the Invention

This invention relates to a method for planning the ordering of components for products and, more particularly, to the application of such a method in an ongoing basis for a number of future time periods, and to the application of such a method to products that are configured-to-order by customers.

2. Background Art

Traditionally, the purpose of maintaining inventory for a manufacturing process has been to decouple various stages of the manufacturing process so that they can be completed independently. In particular, it has been deemed advantageous to carry out the procurement of component parts and raw materials in a manner somewhat separated from the fluctuating day-to-day or even minute-to-minute demands for such parts and materials within the manufacturing process. This decoupling has allowed procurement activities to be separately optimized through such mathematical tools as the well-known economic order quantity (EOQ) model, which was initially developed in the early part of the twentieth century to provide a mathematical means for minimizing the sum of the costs of procurement of parts and materials and the costs of maintaining such parts and materials in inventory.

In general, procurement costs tend to decrease as the volume of parts or material bought with a single order is increased, due to decreases in the costs of placing and tracking fewer orders to maintain a level of production, due to decreases in the cost of shipping a larger quantity at one time, and due to quantity discounts which are often available for larger quantity orders. On the other hand, the cost of maintaining parts and materials in inventory tend to rise with the quantities held, due to additional requirements for warehouse space and insurance protection, and due to the cost of the capital needed to purchase the inventory before it is needed

During the last third of the twentieth century, many manufacturing organizations have turned away from the establishment of large inventories toward the development of a just-in-time (JIT) manufacturing process, in which parts are moved to an assembly process just before they are needed. An origin of JIT manufacturing has been traced to the observation of American supermarket practices by Taiichi Ohno, the chief production engineer of the Toyota Motor Company. He observed that purchase information derived at the check-out lines was used to determine when shelves needed to be restocked with perishable items, which could be left on the shelves for limited times. This process works because the information on the depletion of shelved items is carried to the check-out lines in the customer's shopping cart. At Toyota, a simple card, called a “kanban” after the Japanese word for a placard, was devised to be moved through the manufacturing process with various subassemblies, carrying the needed information. Versions of this system are described in several patents, such as U.S. Pat. No. 5,278,750.

The JIT manufacturing process is applied both to the internal stocking of subassemblies produced by a single manufacturer as part of his manufacturing process and to the procurement of component parts from vendors. Advantages of the JIT manufacturing process include eliminating large expenses typically involved with maintaining large levels of inventory and in the establishment of flexibility in the manufacturing process, providing for the simultaneous manufacture of a large number of different model types without requiring a similarly large number of separate assembly lines fed from separate inventory stocks. The JIT manufacturing process provides another type of flexibility in that changes in demand for various model types may be accommodated without needing to speed up some assembly lines while slowing or eliminating others, and without a need to scrap large inventories of unneeded component parts.

The main disadvantage of JIT manufacturing is that the decoupling function of maintaining traditionally large inventories has been largely eliminated, with the manufacturing process becoming totally dependent on an ability to receive an adequate supply of usable component parts on a day-to-day basis. This dependency has increased the need for methods and systems coordinating planning activities determining future needs for products and component parts with the activities of manufacturing processes and with the activities of vendors supplying component parts.

In this regard, a number of methods have been developed for establishing coordination among several manufacturing sites and collaboration among a manufacturers and suppliers. An example of such a method is described in U.S. Pat. No. 5,983,194 as automatically coordinating a planning system of a first factory with several planning systems of a plurality of factories in a manufacturing chain. Another example of such a method is described in U.S. Pat. No. 6,157,915 as an active collaboration technology in an open architectural framework that delivers information and decision support tools in a timely, contextual and role sensitive manner to present a collaborative dynamic decision making capability to a community of role players within a supply chain. Yet another example of such a method is described in U.S. Pat. No. 6,240,400 as including the steps of identifying a plurality of players in the semiconductor manufacturing capacity market, providing a neural third party with the players and the neural third party configured in a hub arrangement for communicating, and realizing an open market contitionality so that the capacity supplied by the players can be bought and sold.

U.S. Pat. No. 5,974,395 describes a system for extended enterprise planning across a supply chain, with the system including transactional execution system layers for a demand enterprise and for a supply enterprise.

The Internet is providing an increasingly important role in establishing communications and collaboration between manufacturers and suppliers of component parts. In this regard, U.S. Pat. No. 5,953,707 describes a decision support system for managing a supply chain through an architecture including a server side and a client side. The server side includes a database that interfaces with a model engine and performs analysis to support planning decisions. The server side includes a server manager that coordinates requests for service and information.

U.S. Pat. No. 5,369,570 describes a method for continuous real-time management of heterogeneous interdependent resources. The method preferably comprises using multiple distributed resource engines to maintain timely and precise schedules, action controls, and identifying and responding to rapidly changing conditions in accordance with predetermined requirements, relationships, and restraints.

A system providing support for decisions to fill customer orders through purchasing the production capabilities of other manufacturers under certain conditions is described in U.S. Pat. No. 6,044,356.

A system providing for an ongoing planning process is particularly useful in planning for the JIT manufacturing environment. Toward this end, U.S. Pat. No. 5,440,480 describes a system that determines the total demand for a product for each day over four time periods specified by the user of the system. Within the first time period, from the current date up to a demand fence, the total demand cannot be altered. For the next three periods, the total demand for each day can vary by a percentage amount set by the user. If an order exceeding capacity is received for a date beyond the demand fence, the system will recalculate total demand for all days between the demand fence and the order date to fulfill the order, using a formula that prevents an attempt to exceed the amount of material ordered for each day.

Historically, substantial improvements in a manufacturing process have resulted in the dominance of a single type of product at the expense of diversity in the marketplace. For example, after developing the use of the assembly line to produce the Model T automobile in 1908, Henry Ford was quoted as saying that the customer could have any color automobile he wanted, as long as it was black. Then, in 1950, Maurice and Richard McDonald developed a method for producing and delivering a very limited menu of hamburgers and fries quickly and at a very low price. While placing such limitations on products being offered undoubtedly optimized the use of the manufacturing process and aided in the successful establishment of the Ford and McDonald's businesses, competitive pressures eventually force a return to diversity, as evidenced by the development of different automobile colors and models offered by Ford and others, by the successful Burger King “Have it your way” advertising campaign, and by the relative complexity of the menu at a present-day McDonald's restaurant.

In a number of industries, this need for diversity is now being met through the development of configure-to-order (CTO) processes, in which the customer specifies a number of parameters determining the configuration of one or more products being ordered. For example, in the computer industry, a particular system model may be configured by selecting a processor from a number of possibilities, by selecting the type of or size of hard disk drive to be used, by selecting the amount of memory to be provided, and by selecting one or more options, such as an additional hard disk drive or a particular type of adapter card to be installed.

Traditional methods for planning the ordering of components for a manufacturing process assume that the demands for final products to be manufactured are known with and that part supplies and resources are available at any level of requirements, being “unconstrained.” Such assumptions make it relatively straightforward to determine a strategy for ordering “squared sets” of component parts to be entirely consumed by a production process meeting all demands with minimal work in process. Such traditional methods use an “explosion process,” with the known future demand volumes being applied against bills of material providing component level information, in order to obtain lists of component parts which must be ordered at future times. Conventional Material Requirement Planning (MRP) software is used to implement such methods.

However, if the supply of certain component parts is constrained, a solution obtained using the MRP process is often unfeasible, since such a solution may violate the supply constraints. Under such conditions, it is often impossible to satisfy all of the demand for finished products, so the planning process is focused on obtaining squared set of component parts to meet a partial demand.

Techniques such as linear programming and heuristic allocation algorithms are used to select a partial demand function optimized according to a chosen mathematical function such as the maximization of profits.

For example, the problem of constrained material requirements planning is addressed by the method of U.S. Pat. No. 5,630,070, in which data describing elemental steps in the manufacturing process for the production of each end product, as well as the level of demand for each end product, are presented as a set of linear mathematical relationships in a matrix form to be inserted in a computer that determines the optimum number of each end product in accordance with a linear programming optimization algorithm.

This problem is also addressed by a two-step method described in U.S. Pat. No. 5,970,465 for determining the procurement of parts to a procurement system having constraints comprising at least one of constrained resources and known maximum demands. The first step includes constructing a production planning decision space comprising independent sets of hyperplanes defined by decision variables corresponding to product quantities for products. For each part, the second step includes locating a region in the decision space corresponding to a high level of usage of parts.

An IMPLOSION(TM) technology has been developed within IBM for providing feasible and optimal production plans under materials and capacity constraints by using demands, available resources, and a bill of manufacture, describing requirements for materials and capacities, to determine a feasible product mix to meet corresponding to user-defined criteria, such as customer serviceability, profit maximization, inventory minimization, and revenue maximization.

Probably the oldest maxim of the computer age is known by its acronym GIGO, (Garbage In/Garbage Out) to mean that even a well designed and sophisticated computer program will produce only useless results if it is fed erroneous input data. Unfortunately, in the field of production planning, the erroneous input data has often been the data describing expected levels of demand, since, as a practical matter, the demand for finished products is often not well understood at the planning stage, so that event the solutions found by linear programming may be rendered unfeasible by unpredicted changes in the level of demand. Thus, it is understandable that many examples of the patent literature describe methods for determining the demand more accurately or for otherwise dealing with uncertain demand.

For example, in the method of U.S. Pat. No. 5,287,267 a problem including an objective function of minimizing expected excess part inventory while satisfying a constraint that a specified service level is met for all products is transformed into an unconstrained problem through the use of a Lagrange multiplier. The solution is achieved, even when the actual demand for the products is not known, by performing a one-parametric search of the value of the multiplier.

A method that has been developed for dealing with various types of uncertainty involves a scenario-based analysis, in which scenarios are used to gain insights needed to plan effectively for an uncertain future. The use of this technique for production planning with uncertain demand is described in U.S. Pat. No. 6,138,103. In a first step, the uncertainty of the demand environment is represented by employing a scenario-based analysis including the steps of performing multiple optimization runs against different demand scenarios. Then, in a second step, an implosion technology is combined with the scenario-based analysis to generate, for any one individual demand scenario, a deterministic solution that is optimal for the particular demand scenario.

A number of other patents also address the problem of uncertain demand by improving the tools used to estimate demand. For example, U.S. Pat. No. 5,299,115 describes a method for storing demand data and for using such data, together with other data, to determine levels of demand for current and near-future periods. U.S. Pat. No. 5,914,878 describes production system for retail goods that includes the timely collection of point of sales data from retail outlets and the flexible production of the goods in response to this data. U.S. Pat. No. 6,078,893 describes a method for tuning a demand model in a manner that is stable with respect to fluctuations in sales history, with a market model being selected to predict how a subset of the parameters in the demand model depend upon information external to the sales history. U.S. Pat. No. 6,205,431 describes a method for forecasting intermittent demand, in which sample reuse techniques are used to build a distribution of predicted cumulative lead time demand values that can be statistically analyzed.

U.S. Pat. No. 5,712,985 describes a method creating production schedules for various items by describing a forecast demand for the items during a number of future time intervals, with profiles stored for the items describing variations in demand due to influencing factors, such as promotional sales, holidays, and weather variations.

Improved tools for estimating levels of demand can also be applied at the marketing level. Toward this end, U.S. Pat. No. 6,009,407 describes a computer-implemented method for merging product marketing control and product inventory control to generate a segment-level consumer choice model for a plurality of competing brands, and to aggregate that model to a market-level consumer choice level. A cost-minimized base stock level and a demand forecast is generated for each of the brands.

Other patents describe particular methods for allocating resources. For example, U.S. Pat. No. 5,826,236 describes a scheduling computer system that temporarily allocates resources to a process selected based on the attributes of processes and resources, as well as desired process start and end times, avoiding the selection of process for which resources have already been allocated, and then calculating a resulting time value and fitness value. The system then optimizes the resource for a particular process.

Another method for resource allocation is described in U.S. Pat. No. 6,049,774 as responding to various requests, such as from customers, for products and services, determining a preferred scheme for allocating resource, over a plurality of time periods to provide the requested products or services.

U.S. Pat. No. 5,845,258 describes a strategy driven planning system including a plan defining a scheduled operation of a user environment A planning engine is coupled to the user environment, being operable to identify a plurality of problems by comparing the plan to the behavior and constraints defined by the environment, and is further operable to adjust the plan according to a selected strategy, interacting with the user through a user interface.

What is needed is a method for efficiently planning component purchase activities for a mixture of products including a number of configure-to-order products having configurations determined by customers during the ordering process. Additionally, what is needed is a method for handling responses from suppliers to commit for supplying parts in future time periods and from customers to order products for future time periods. Furthermore, what is needed is a method for applying an ongoing planning process, reacting to changes in levels of vendor commitments and customer orders over time.

### SUMMARY OF THE INVENTION

In accordance with a first aspect of the invention, a system is provided for planning the ordering of components for a number of products. The system includes communication means for communicating over a computer network, data storage, and processor means. The data storage stores a demand forecast data structure storing data describing volumes of components for products within the plurality thereof expected to be required during time periods within a plurality of time periods, a customer order log data structure storing data describing orders placed by customers over the computer network for products within the plurality thereof for the time periods, a supplier order log data structure storing data describing orders placed with suppliers for components of the products, a net demand forecast data structure describing volumes of the components remaining to be ordered for the time periods, a committed parts data structure storing data describing volumes of the components committed over the computer network by suppliers of the components to be supplied for the time periods, and a committed volumes data structure storing data describing volumes of the products which can be built with volumes of the components within the committed parts data structure. The processor means is programmed to determine volumes of the components to be stored in the net demand forecast data structure for the time periods by subtracting volumes of components from the supplier order backlog data structure from volumes of components within the demand forecast data structure, to prepare data from the net demand data structure for the time periods for transmission to suppliers of the components, and to determine, for storage of data in the committed volumes data structure, volumes of the products to be built for the time periods with components for which data is stored in the committed parts data structure.

The processor means may reside in a single computer system or in a number of computer systems connected to transmit data to one another.

Preferably, the number of products includes one or more configure-to-order products and one or more fixed configuration products. Customer orders for configure-to-order products include specifications of their configurations. The data storage preferably additionally stores a bill of materials data structure including a number of building block data structures defining the components in configure-to-order products and a number of product data structures, each of which defines the components in a fixed configuration product. The building bock data structures for each configure-to-order product describe all of the components used to build the product. A single product data structure describes all of the components used to build a fixed configuration product. In other data structures, the names identifying the building block data structures and the product data structures are used, together with the bill of materials data structure to describe the products to be built and the components needed to build these products.

In accordance with another aspect of the invention, data storage is provided, with the data storage having recorded thereon computer readable data for use in a process ordering component parts for fixed configuration products and for configure-to-order products. The computer readable data includes a number of product data structures, a number of building block data structures, and a planning data structure for storing data used in planning. Each product data structure in the number of product data structures includes entries listing each component part within a fixed configuration product associated with the product data structure and a quantity of the component part within the fixed configuration product associated with the product data structure. Each building block data structure in the number of building block data structures includes entries describing component parts associated with the building block data structure forming a portion of a configure-to-order product and a quantity of the component part within the portion of the configure-to-order part. Each of the configure-to-order products includes component parts within a number of building block data structures in the number of building block data structures. The planning data structure includes a number of fixed-configuration product entries identifying a product data structure in the number of product data structures, a number of configure-to-order entries identifying a configure-to-order product. and a number of building bock entries associated with each of the configure-to-order entries.

Each of the building block entries identifies a building block data structure in the number of building block data structures. The component parts described in the building block data structure are used within a version of the configure-to-order product.

The data storage is understood to be, for example, a single magnetic medium or a combination of singular or plural magnetic media and memory structures.

According to yet another aspect of the invention, a method is provided for determining volumes of groups of component parts to order within constraints of a planned demand for products built with said component parts and within constraints of an available supply of said component parts, during a number of time periods. The method includes:

for each time period within said number of time periods, and for each of said groups, determining a supplier of each component part, and for each supplier of component parts within said groups of component parts, generating a parts demand data structure describing each of said component parts supplied by said supplier in a volume required to meet said planned demand for products built with said component parts;

transmitting data from said parts demand data structure for each said supplier to said supplier;

for each said supplier, receiving data describing a volume of said component parts described within said data from said parts demand data structure that can be supplied during said each said time period, and writing said data received from said supplier to a committed parts data structure;

for each of said component parts, determinating a cumulative supply volume from said data received from said suppliers and a cumulative demand volume from said planned demand for products built with said component parts for each time period within said number of time periods; and

for each of said groups, and for each time period within said number of time periods, determining a maximum volume of said group that can be built within said time period, wherein a volume of each component part in said maximum volume of said group is not greater than said cumulative supply volume of said component part, and wherein said volume of each component part in said maximum volume of said group is not greater than said cumulative demand volume of said component part, and writing said maximum volume of each said group to a committed group volumes data structure.

According to another aspect of the invention a method is provided for planning ordering of component parts for products within a number of products over a number of time periods in accordance with customer orders for the products. The method includes sequentially performing a planning process during sequentially occurring time periods. The planning process, which is performed for a number of time periods, includes:

determining demand volumes of groups of the component parts needed for planning volumes of the products in each time period within the number of time periods;

determining net volumes of the groups of the component parts by subtracting volumes of the groups on order from the demand volumes;

deriving volumes of the component parts from the net volumes of the groups;

transmitting volumes of the component parts to suppliers of the component parts;

receiving committed volumes of the component parts from the suppliers of the component parts;

deriving committed volumes of the groups of the component parts from the committed volumes of the committed parts;

deriving committed volumes of the products from the committed volumes of the groups;

receiving orders from customers for the products;

deriving committed customer ordered volumes of the products from orders from customers for volumes of the products within the committed volumes of the products;

transmitting committed status information to the customers in response to deriving committed customer ordered volumes of the products, and

ordering volumes of the component parts from the suppliers.

### BRIEF DESCRIPTION OF THE DRAWINGS

FIG. 1 is a block diagram of a system configured for planning and ordering components for a configure-to-order manufacturing process in accordance with the present invention;

FIG. 2 is a block diagram of a planning computer within the system of FIG. 1;

FIG. 3 is a flow chart showing the flow of data within the system of FIG. 1;

FIG. 4 is a fragmentary pictographic view of a product information data structure provided as an input to a demand planning process occurring within the data flow of FIG. 3;;

FIG. 5 is a fragmentary pictographic view of a planning volumes data structure provided as an input to the demand planning process occurring within the data flow of FIG. 3;;

FIG. 6 is a fragmentary pictographic view of a customer order log data structure provided as an input to the demand planning process occurring within the data flow of FIG. 3;

FIG. 7, of which FIG. 7A is a left portion and FIG. 7B is a right portion, is a flow chart of the demand planning process occurring within the data flow of FIG. 3;

FIG. 8 is a flow chart of an explode process occurring during supply chain planning within the data flow shown in FIG. 3;

FIG. 9 is flow chart showing a flow of data within an implode and squaring process occurring during supply chain planning within the data flow shown in FIG. 3;

FIG. 10 is a flow chart of a first accumulation process within the implode and squaring process occurring within the data flow of FIG. 9;

FIG. 11, of which FIG. 11A is an upper portion and FIG. 11B is a lower portion, is a flow chart of a first squaring process within the implode and squaring process occurring within the data flow of FIG. 9;

FIG. 12 is a flow chart of a second accumulation process within the implode and squaring process occurring within the data flow of FIG. 9; and

FIG. 13, of which FIG. 13A is an upper portion, FIG. 13B is a central portion, and FIG. 13C is a lower portion, is a flow chart of a second squaring process within the implode and squaring process occurring within the data flow of FIG. 9.

### DETAILED DESCRIPTION OF THE INVENTION

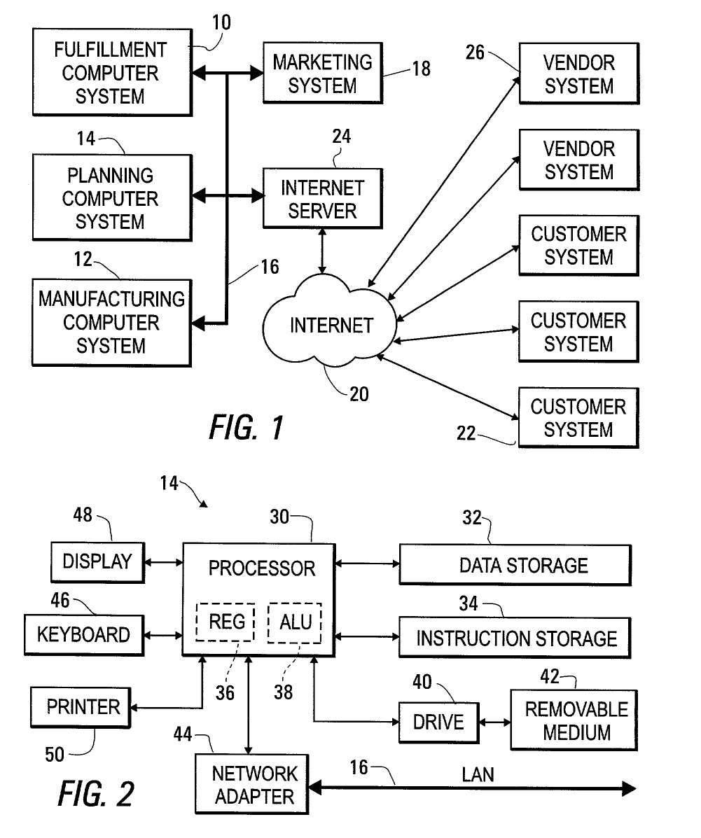

FIG. 1 is a block diagram of a system configured for planning and ordering components for a configure-to-order (CTO) manufacturing process in accordance with the present invention. The major computer systems are a fulfillment computer system 10, a manufacturing computer system 12, and a planning computer system 14, all of which are connected to transfer information through a local area network (LAN) 16. The fulfillment computer system 10 receives and tracks customer orders and provides information to customers concerning the status of such orders, including commitments from the manufacturer to supply systems according to a schedule. The manufacturing computer system 12 includes manufacturing data, including the present levels of inventories of components. The planning computer system 14 executes planning operations in accordance with the present invention, using data transmitted along the LAN 16 from the fulfillment computer system 10 and from the manufacturing computer system 12, and also transmitting information to update records stored within these computer systems 10, 12.

Also in accordance with a preferred version of the invention, at least some of the products being planned and manufactured are CTO products that are configured to order as they are ordered by customers. This CTO process causes variations in a number of the components used to build individual systems, generally adding to the difficulty of predicting future rates of usage of individual components. The CTO process also increases the importance of maintaining sufficient inventory of components, since a level of customer confidence depends on an ability to manufacture products configured as specified in the CTO process. Customer orders placed with sales representatives are entered through a marketing system 18. Alternately, customer orders may be entered through the a computer network, such as the Internet 20, from customer systems 22 having conventional browsers, which are connected to the Internet 20, for example, through Internet service providers (not shown).

The LAN 16 is also connected to a server, which provides for communications through a computer network, such as the Internet 20. The server generates web pages which are used within the customer systems 22 to generate CTO orders. Data derived from these CTO orders, and for products having fixed configurations, is transferred from the Internet server 24 to the fulfillment computer system 10 along the LAN 16, to be stored in a data structure of customer orders. After such orders are placed, the results of the planning process occurring within the planning computer system 14 are used to generate commitments to fulfilling orders, with such commitments being transmitted to the appropriate customer systems 22 through e-mail over the Internet 20. Data from the marketing system 12 and from the Internet server 24 is transmitted through the LAN 16 to be stored in a data structure of customer orders within the fulfillment computer system 10.

Vendor systems 26, operated by suppliers of components used in the manufacturing process are also connected to the Internet 20 through Internet service providers (not shown). This connection is used to transmit web pages from the Internet server 20 to the individual vendor systems 22, indicating a forecast demand schedule for components supplied by the various individual vendors. The individual vendor then supplies data through his vendor system 22 to the web pages, forecasting his ability to supply components according to the forecast demand schedule from the manufacturer. Such data may be supplied as a keyboard input to the vendor system 26 or as spreadsheet data transferred to the web pages from another application running in the vendor system 26 or in another computing system (not shown) communicating with the vendor system 26.

Such data, indicating the capability of each vendor to supply various components according to the forecast demand schedule, is transmitted from the Internet server 24 over the LAN 16 to the planning computer system 15, for use within the planning process. The subsequent outputs of this planning process include committed orders that are transmitted from the planning computer system 14 along the LAN 16 to the Internet server 24 for transmission over the Internet 20 to the appropriate vendor systems 26.

FIG. 2 is a block diagram of the planning computer system 14, which includes a processor 30, data storage 32, and instruction storage 34. Data storage 32 and instruction storage 34 may comprise different portions of one or more storage devices, including random access memory and magnetic storage devices such as hard disk drives. The processor 30 is preferably of a conventional type, including a register 36 storing data for processing and an arithmetic logic unit 38. The computer system 14 also includes a drive 40 reading data from a removable medium 42. The removable medium 42 may be a rotating magnetic medium, such as a floppy disk, an optical medium, such as a compact disk, or a magnetic tape. The planning computer system 14 also includes a network adapter 44, providing connection to the LAN 16. User inputs to the planning computer system 14 may be provided through a keyboard 46. Outputs from the planning computer system may be displayed on a display device 48 and also may be printed on a printer 50.

Data is also transmitted along the LAN 16, forming inputs to the planning computer system 14 and outputs therefrom. Data is transferred in this way between the planning computer system 14 and the other computer systems 10, 12, 18, 24 shown in FIG. 1. Data may also be transmitted between the computer system 14 and other computer systems and databases (not shown).

The instructions for a program executing within the processor 80 are typically read from instruction storage 34, which is understood to be a computer usable medium storing such instructions. Instructions for such a program may also be stored in the removable computer usable medium 42 as a computer program product for loading into the instruction storage 34. Alternately, instructions for such a program may be provided as a computer data signal embodied on a carrier wave and transmitted through the LAN 16 or through the Internet 20.

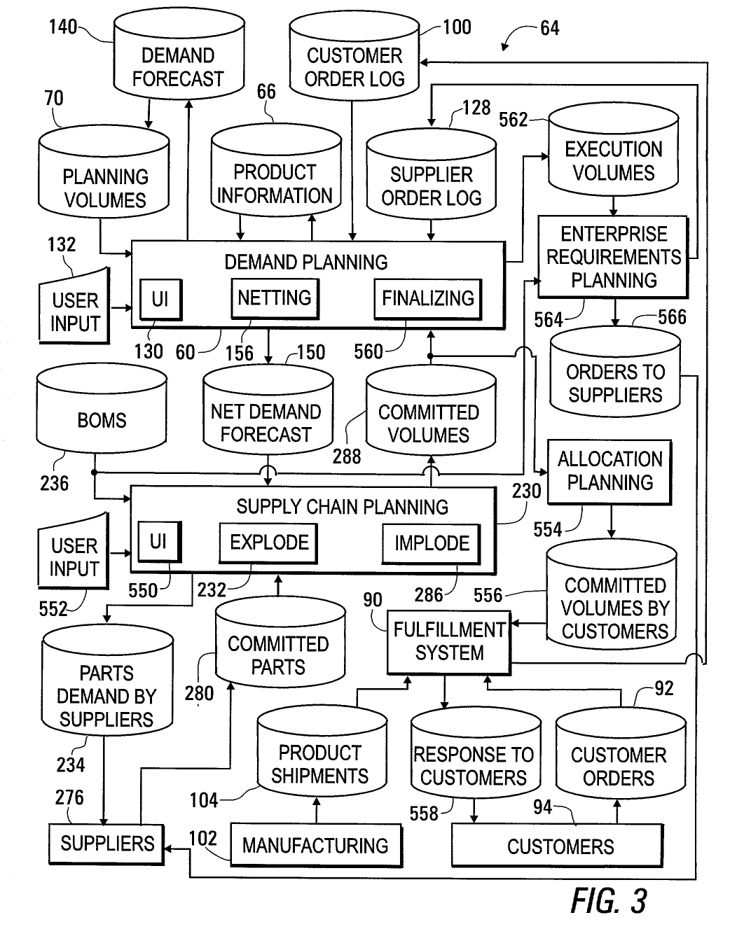

FIG. 3 is a flow chart showing the flow of data within the system of FIG. 1 in accordance with the invention. A demand planning process 60 begins with receiving data from various data structures 64. These data structures 64 are available within the planning computer system or within other databases and computer systems from which data may be accessed through the LAN 16. Following an initial period, when data has to be prepared by other means to start the planning process, much of the data within these data structures 64 has been derived during previous operations of the planning process 60, resulting in an ongoing process.

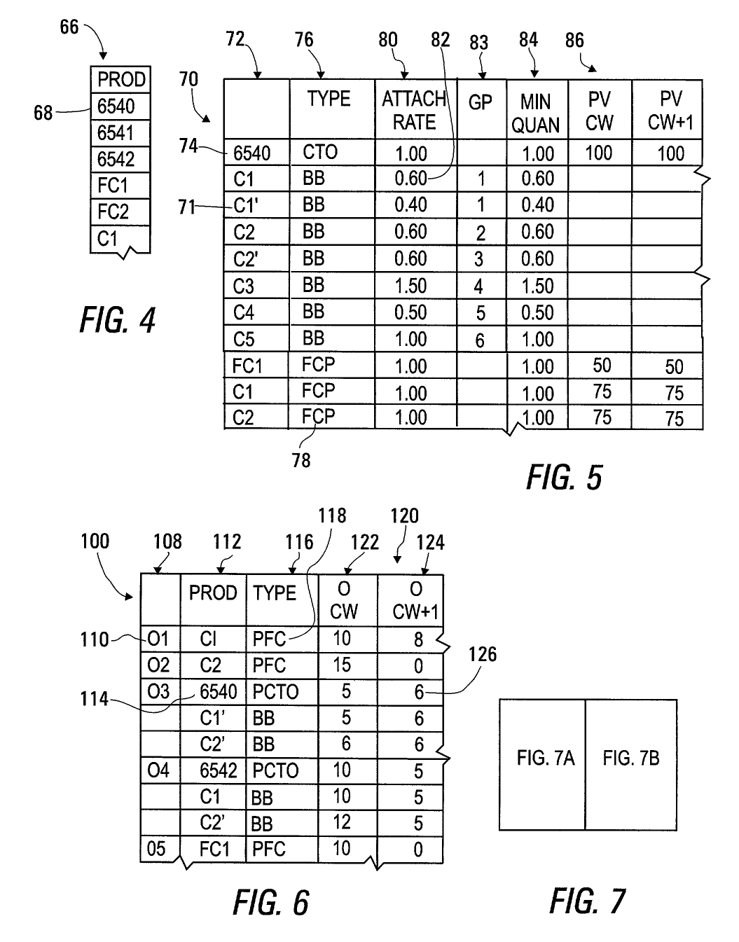

FIG. 4 is a pictographic view of a product information data structure 66 within the data structures 64. The product information data structure 66 provides a list of products 68 for which the planning process 60 is to be applied.

FIG. 5 is a pictographic view of the planning volumes data structure 70, also provided as one of the input data structures 64. The data structure 70 includes a number of entries 71, each of which corresponds to a product or building block being planned. This data structure 70 includes a first field 72 storing variables 74 identifying various identifying items and a second field 76 storing codes identifying the types of items, which are either configure-to-order products identified as CTO, building blocks identified as BB and used within the configure-to-order product listed above, or fixed configuration products identified as FCP. The data structure 70 also includes a third field 80 storing values identifying the attach rates 82 of each of the building blocks and a fourth field 84 indicating a minimum quantity, Q_{M}, of each building block to be used in the CTO products in which the building block is used.

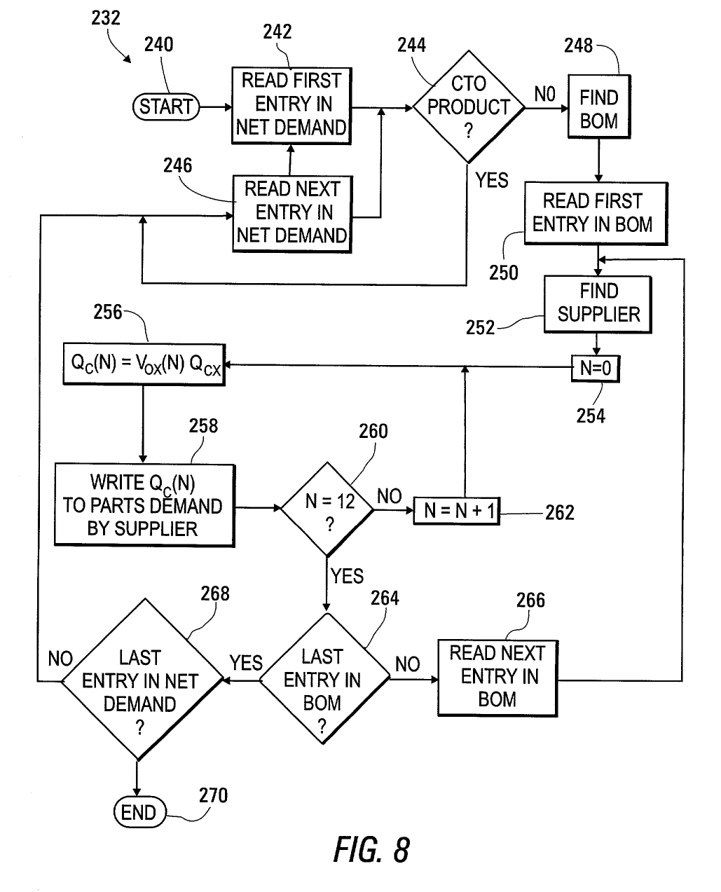

Each entry for a CTO product is followed by a number of entries for building blocks, identified as BB, each of which goes into at least a portion of the CTO product. The building block concept is used to provide a convenient method for handling the allowable differences within CTO product types throughout the planning process. No planning volumes are shown in the data structure 70 for the building blocks, identified in the second field 78 by the code BB. The attach rates given for these items are understood to apply to the planned volumes given for the product in which they are used for each of the weeks in the data array 144. This product is the product having an entry above the list of building blocks. Thus, in the example of FIG. 8, the building blocks C1, C1′, C2, and C2′ each go into the 6540 product, with the 0.60 attach rate of C1 indicating that a volume of 60 C1 building blocks expected to be used in 100 6540 products planned for the current week and also for the next week.

A building block may include a single component part or a number of component parts. For example, in an electronic product, a power supply building block may include a power supply unit, several screws attaching the power supply unit into the housing of the device, and a cable to be attached to extend between the power supply and other components within the electronic product. These component parts may be considered part of the building block even when they are ordered and stocked separately, and even though they are not joined to one another as a separate subassembly before the process of finally assembling the electronic product.

Many building blocks have attach rates, listed in the third field 80 of the demand data structure 70, less than 1.00. According to the example of FIG. 5, it has been estimated that 60 percent of the 6540 products will include the C1 building block, indicated by an attach rete of 0.60, while the remaining 40 percent of these products will include the C1′ building block, indicated by an attach rate of 0.40.

Each building block is considered to be a part of a building block group, indicated in a fourth data field 83 within the demand data structure 70. Two or more building blocks within the same building block group are provided as alternatives to be chosen by the customer in the CTO process. Thus, the number of CTO products that can be built with a building block group is determined by a sum of the usage of each building block within the group.

While the attach rates indicate the number of each building block expected to be desired, and therefore ordered by customers, within the product, the minimum quantities listed in the fifth field 84 provide indications of the numbers of each building block needed within the product before it can be shipped. In the example of FIG. 5, each product having the C1 building block must have one of them, so the minimum quantity for the C1 building block is equal to its attach rate. On the other hand, for the C3 building block, it has been estimated that half of the product, as desired, will have two of these building blocks, while the other half of the product will have only one of these building blocks. To be shipped, each of the products must have at least one of the C3 building blocks. Thus, the attach rate of the C3 building block is given as 1.50, but the minimum quantity is given as 1.00. For example, the C3 building block may be a hard disk drive to be installed in a computing system, with each system needing one hard disk drive, and with some systems expected to be ordered with two hard disk drives.

Other building blocks are truly optional. For example, the C4 building block has an attach rate of 0.50, but a minimum quantity of 0.00, indicating that the customers buying the product is expected to order this building block for half the products, but that these products can be shipped without this building block. For example, the C4 building block may be an optional adapter card within a computer product.

Each CTO product includes a common building block, which includes all of the component parts used in each example of the CTO product, regardless of the other building blocks making up the product. Thus, the common building block contains, for example, frames, covers, and various device used in each of the products. Both the attach rate and the minimum quantity of the common building block are 1.00, as shown in the example of the building block C5 in FIG. 5.

The data structure 70 further includes a data array 86 of thirteen fields, each of which stores projected planning volumes for each of the products identified in the first field 72 during each of the thirteen weeks identified within the current planning cycle. Each of these weeks is identified in the form CW+N, where CW represents the current week of the planning cycle and N is a variable having a value from zero to twelve. Each product, whether a configure-to-order product or a fixed configuration product has an associated planning volume for each of these weeks, with a value of zero indicating that no units of the product are being planned for a particular week.

No planning volumes are shown in the data structure 70 for the building blocks, identified in the second field 78 by the code BB. The attach rates given for these items are understood to apply to the planned volumes given for the product in which they are used for each of the weeks in the data array 144. This product is the product having an entry above the list of building blocks. Thus, in the example of FIG. 8, the building blocks C1, C1′, C2, and C2′ each go into the 6540 product, with the 0.60 attach rate of C1 indicating that a volume of 60 C1 building blocks expected to be used in 100 6540 products planned for the current week and also for the next week.

As described above in reference to FIG. 1, the fulfillment computer system 10 receives and tracks customer orders processed through the Internet server 24 and the marketing system 18. Thus, continuing to refer to FIG. 3, the fulfillment system process 90 receives customer order data 92 from customers 94 and maintains an order backlog data structure 100. As products are shipped to the customers, the manufacturing system process 102, operating in the manufacturing computer system 12 (also shown in FIG. 1) develops product shipment data 104, which is transferred to the fulfillment system process 90, so that customer orders which have been filled by the shipment of products are removed from the order backlog data structure 100.

FIG. 6 is a pictographic view of an order log data structure 100 among the data structures 64. The data structure 100 includes a first field 108 having an order number 110 identifying each order from a customer, a second field 112 identifying each product 114 being ordered, and a third field 116 including a type code 118, defined as explained above in reference to FIG. 5. A single order may result in the generation of several entries for this data structure 100, because a CTO product is ordered, so that one or more building blocks must be listed, or because more than one different product is ordered with a single order. Beyond the third field 116, there are thirteen quantity fields 120, including one field for each of the weeks for which a demand forecast is being prepared, starting with a fourth field 122 for the current week and a fifth field 124 for the week following the current week. Each value 126 in the quantity fields 120 represents a number of the items 114, whether such items are products or building blocks, ordered in the particular order identified in the first field 108.

The data structures 64 providing inputs to the demand planning process 60 also includes a supplier order log data structure 128. While orders to suppliers are placed in terms of individual components, the supplier order log includes products, indicating that all the necessary component parts for a product have been ordered, and building blocks listed under the entries for CTO products, indicating the building blocks within the CTO products for which all of the component parts have been ordered. Thus, the format of the data structure 128 is the same as that of the order log data structure 100, as shown in FIG. 6.

Continuing to refer to FIG. 3, the demand planning process 60 also includes a user interface 130, providing users with a way to view data structures available within the demand planning process 60, and further providing a means for accepting user inputs 132. For example, these user inputs 132 may be used to make changes in the product information data structure 66 and to set flags stored in registers in order to configure the operation of the demand planning process 60.

The demand planning process 60 determines a volume level of each product, and of each building block within CTO products, expected to be required during the 13-week period covered by the plan being developed, on basis unconstrained by limitations in the supply of component parts. These volume levels are stored in a demand forecast data structure 140, which has a format similar to the planning volumes data structure 70, as shown in FIG. 5, except that, in the demand forecast data structure 140, weekly volumes for building blocks are shown instead of attach rates. Within the demand planning process 60, a demand forecast netting process 156 further determines the quantity of products and building blocks remaining to be ordered, still on a basis unconstrained by limitations in the supply of component parts, by subtracting the volume levels already ordered for each of the 13 weeks from the volume level expected to be required. The volumes of products and building blocks for which components are remaining to be ordered are stored in a net demand forecast data structure 150, which has a format similar to that of the demand forecast data structure 140. For each week, N weeks after the current week, with 0≦N≦12, the volume, V_{OP}(N), of a product P for which parts are to be ordered, is given by:

V_{OP}(N)=V_{P}(N)−O_{P}(N) 1)

where V_{P}(N)=the planning volume of the product P, taken from the weekly data array 144 of the planning volumes data structure 70, and

O_{P}(N)=the volume of the product P for which components are already on order, taken as the sum of all orders for the product P in the week CW+N in the supplier order log data structure 128.

Similarly, for a building block B used within the product P, the volume, V_{OB}(N), of the building block to be ordered is given by:

V_{OB}(N)=V_{B}(N)−O_{B}(N) 2)

where V_{B}(N)=the planning volume of the building block B, and

O_{B}(N)=the volume of the building block B for which components are already on order, taken as the sum of all orders for the building block B in the week CW+N in the supplier order log data structure 128.

The planning volume of the building block B is calculated from the planning volume of the product in which the building block is used. If the attach rate is to be held at a predetermined level for the entire quantity of the building block used during the week N, this attach rate is defined as:

$${R}_{B} = \frac{{V}_{B} ( N )}{{V}_{P} ( N )} \qquad 3 )$$

where Vₚ (N)=the planning volume of the product P in which the building block B is used.

Thus, the planning volume of the building block B is given by:

V_{B}(N)=R_{B}V_{P}(N), 4)

and, when equation 4) is substituted into equation 2), the volume of building blocks for which components are to be ordered, which is stored in the net demand forecast data structure 150, is determined to be given by:

V_{OB}(N)=R_{B}V_{P}(N)−O_{B}(N) 5)

On the other hand, if the attach rate is to be held at a predetermined level for the products not yet ordered by customers, the attached rate is defined as:

$${R}_{B} = \frac{{V}_{B} ( N ) - {V}_{B0} ( N )}{{V}_{P} ( N ) - {V}_{P0} ( N )} \qquad 6 )$$

where V_{PO}(N)=the volume of the product P, in which the building block B is used, already on order by customers, and

V_{BO}(N)=the volume of the product P already ordered by customers with the building block B.

Thus, the planning volume, for the demand forecast data structure 152 of the building block B is given by:

V_{B}(N)=R_{B}[V_{P}(N)−V_{PO}(N)]+V_{BO}(N) 7)

and, when equation 7) is substituted into equation 2), it is determined that the volume of building blocks for which components are to be ordered, as stored in the net demand forecast data structure 150, is given by:

V_{OB}(N)=R_{B}[V_{P}(N)−V_{PO}(N)]+V_{BO}(N)−O_{B}(N). 8)

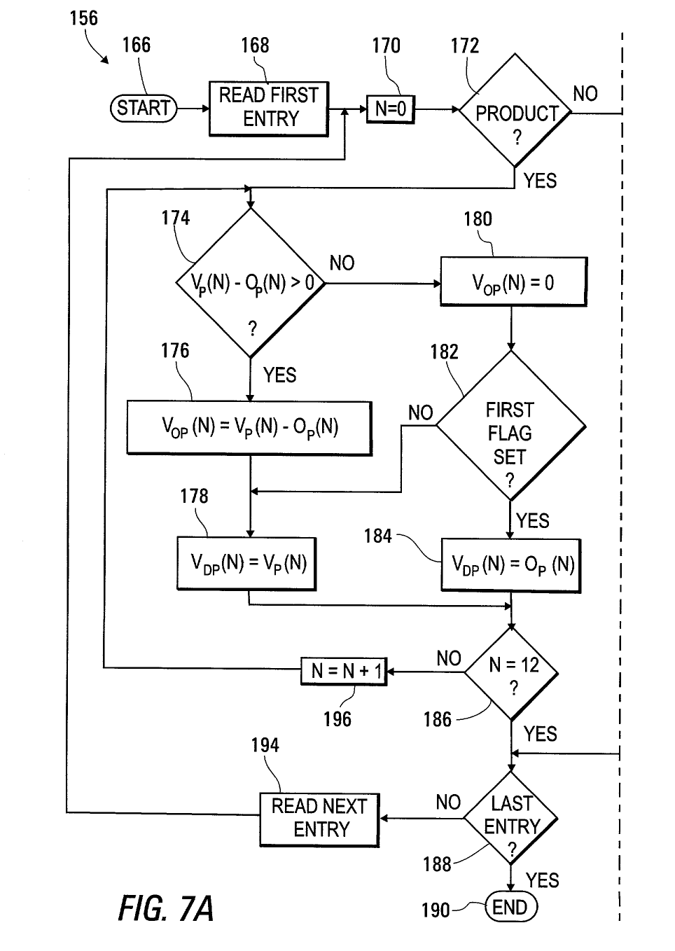

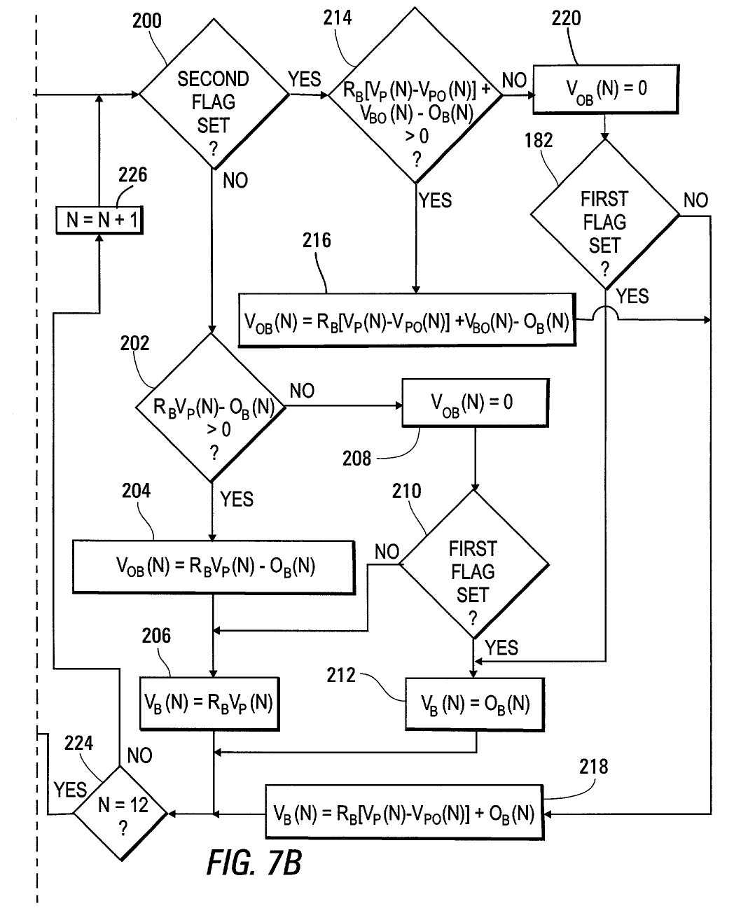

FIG. 7 is a flow chart of processes occurring during the demand planning process 60. FIG. 7 is comprised of a left portion, indicated as 7A, and a right portion, indicated as 7B.

Referring to FIGS. 5 and 7, after the demand planning process 60 is started in step 166, the first of the entries 71 within the planning volumes data structure 70 (shown in FIG. 5) is read in step 168. Then, in step 170, the value of N is set to zero, to perform calculations for the current week. Next, in step 172, a determination is made of whether the entry 71 is for a product or a building block, by examining the code 78 read from the second field 76 of the entry. If the entry is determined to be a product, whether a configure to order product or a product having a fixed configuration, the system proceeds to step 174, in which a determination is made of whether components for the product must be ordered to meet the planning volume, V_{P}(N), with the volume of products for which parts are to be ordered, V_{OP}(N), being defined by Equation 1).

If this determination indicates that components must be ordered for at least some of the planned volume, the volume of products for which such components are to be ordered is set to the level determined by Equation 1) in step 176, with this volume V_{OP}(N) being written to the corresponding entry and field within the weekly data array 162 of the net demand forecast data structure 150. Then, in step 178, the planning volume, V_{P}(N), is written to the corresponding entry and field within the weekly data array of the demand forecast data structure 140.

On the other hand, if it is determined in step 174 that components on order are sufficient to cover the volume of products planned fo the week specified by N, the volume of products for which components to be ordered is set to a value of zero in step 180. This value is also written to the corresponding entry and field within the weekly data array of the net demand forecast data structure 150. Next a first flag bit, which can be set through user input 132 to configure the demand planning process 60, is examined in step 182. If the flag bit is not set, the planning volume, V_{P}(N), is written in step 178 to the corresponding entry and field within the weekly data array of the demand forecast data structure 140. If the flag bit is set, as determined in step 182, the volume of products ordered, O_{P}(N), is written in step 178 to the corresponding entry and field within the weekly data array of the demand forecast data structure 140. Generally, such a change may be considered to correct the planning volume, which had been set too low to cover existing orders.

After data is written to the demand forecast data structure 150 in step 178 or in step 184, a determination is made in step 186 of whether N has a value of 12, indicating that calculations with data taken from the last week within the weekly data array 86 of the planning volumes data structure 70 have been completed. If they have been completed, the system proceeds to step 188, in which a determination is made of whether the last entry 71 within the planning volume data structure 70 has been read. If it has, the demand forecast netting process 156 ends in step 190. If the last entry 71 has not yet been read, the next entry 71 in the planning values data structure 70 is read in step 194, so that the system addresses the next entry in step 172, after resetting N in step 170 to work with the current week. If the value of N is not yet 12, it is increased by one in step 196, with the system then returning to step 174 to begin generating the data to be stored in the next entry of the demand forecast 140 and the net demand forecast 150.

When a determination is made in step 172 that the entry read from the planning volumes data structure 70 represents a component or a building block, not a product, the system proceeds to step 200, in which a determination is made of whether a second flag bit has been set. This second flag bit is set or reset by an operator input 132 (shown in FIG. 3) to determine that the volume of a building block will be planned by applying the predetermined attach rate for the building block to the portion of the planned volume of the product into which customer orders have not yet been placed for the time period identified by N. If the second flag bit is not set, the attach rate is applied to the entire volume of the product being planned, regardless of the rate at which the building block is attached within products previously ordered by customers. The first of these methods is appropriate if certain types of orders, which tend to skew the attach ratio, and which tend to occur early in a cycle, have been taken into account in the planning process. The second of these methods is appropriate if the attach rate is believed to be independent of the time at which orders are placed.

Thus, if the second flag bit is not set, the planning volume of a building block for the time period identified by N is given by Equation 4), while the volume of the building block remaining to be ordered for this time period N is given by Equation 5). If a determination is made in step 200 that the second flag bit is not set, the system proceeds to step 202, in which a determination is made of whether the volume of parts to be ordered for the week identified by N is, as given by Equation 5) is greater than zero. If it is greater than zero, this volume, which is stored in the net demand forecast data structure 154, is set to the value predicted by Equation 5) in step 204. Then, in step 206, the planning volume of the building block, which is stored in the demand forecast data structure 152, is set to the value predicted by Equation 4).

In each case, in the evaluation of the equations, the building block attach rate, R_{B}, is that value read in step 194 for the present entry, while the planning volume for the product in which the building block is used, V_{P}(N) is the value read, either in step 194 or in step 168 for the previous product entry, in which the presently considered building block is placed. These planning volumes for the product are retained for use with each building block listed following a product entry (i.e., for each building block going into the product), to be reset only when the next product entry is read in step 194.

If it is determined in step 202 that the volume of this building block, as given by Equation 4), to be yet ordered is less than zero, it is known that no parts should be ordered at this time, so this volume is set to zero in step 208. Then, in step 210, it is determined whether the first flag bit has been set. If the first flag bit has not been set, the system proceeds to step 206, so that the planning volume value to be stored in the demand forecast data structure 152 is set at the value predicted by Equation 4). If the first flag bit has been set, the planning volume value is instead set, in step 212, to the volume of this building block which has been ordered by customers through the CTO process.

On the other hand, if the second flag bit is set, the planning volume of the building block for the time period identified by N is given by Equation 7), while the volume of the building block remaining to be order for this time period N is given by Equation 8). Therefore, when it is determined in step 200 that the second flag bit has been set, the system proceeds to step 214, in which it is further determined whether the volume of the building block predicted to be yet ordered by Equation 8) is greater than zero. If it is greater than zero, this volume, which is then stored in the net demand forecast data structure 150, is set in step 216 to the value predicted by Equation 8). Then, in step 218, the planning volume of the building block, which is then stored in the demand forecast data structure 140 is set the value predicted by Equation 7).

If it is determined in step 214 that the volume of this building block, as given by Equation 8) to be yet ordered is less than zero, this volume is set to zero in step 220. Then, in step 222, it is determined whether the first flag bit has been set. If it has not been set, the system proceeds to step 218, so that the planning volume value to be store in the demand forecast data structure 140 is set to the value predicted by Equation 7). If the first flag bit has been set, the planning volume value in the demand forecast data structure 140 is instead set, in step 212. to the volume of this building block which has been ordered by customers through the CTO process.

In each case, after the planning volume of the building block is calculated and stored in step 206, 212, or 218, a determination is made in step 224 of whether N is 12. If it is not, a value of one is added to the value of N in step 226, and the system is returned to step 200 to begin considering data for the next week. Returning to step 200 in this way allows the second flag to be set differently for different weeks. If it is determined in step 224 that N=12, the system returns to step 188, in which it is further determined whether the last entry of the planning volumes data structure 70 has been read. If it has the demand forecast netting process ends in step 190, or the next entry of the planning volumes data structure 70 is read in step 194.

The supply chain planning process 230 includes an explode process 232, in which the products and building blocks listed as entries in the net demand forecast data structure 150 are expanded into a number of parts demand data structures 234. In this explosion process 232, various bill of materials data structures 236 are used to determine the component parts to be included in each fixed configuration product and for each building block for a CTO product. Each fixed configuration product and each building block is associated bill of material data structure 236 including entries listing each component part and its quantity to be used within the fixed configuration product or the building block. The component part is listed by an identifying code, such as a part number. For each fixed configuration product entry in the net demand data forecast 150, the quantity of each component, Q_{C}, is given by:

Q_{C}(N)=V_{OP}(N)Q_{CP} 9)

where V_{OP}(N)=the net demand value for the product from the net demand forecast data base 150,

Q_{CP}=the quantity of the component within the product from the bill of material data base 236 associated with the product.

Similarly, for each building block entry in the net demand data forecast 150, the quantity of each component, Q_{C}, is given by:

Q_{C}(N)=V_{OB}(N)Q_{CB} 10)

where V_{OB}(N)=the net demand value for the building block from the net demand forecast data base 150,

Q_{CB}=the quantity of the component within the building block from the bill of material data base 236 associated with the building block.

Each entry in the bill of material data structure 236 may also include information identifying a supplier from which the associated component part is to be purchased. Alternately, information identifying. Otherwise, a number identifying the entry in the bill of material data structures must be matched with a supplier list.

FIG. 8 is a flow chart of the explosion process 232 within the supply chain planning process 230. After this process 232 is started in step 240, the first entry in the net demand forecast 150 is read in step 242. Then, in step 244, a determination is made of whether the entry describes a CTO product, as shown, for example, by “CTO” in the second data field of the net demand data forecast 150. If the entry describes a CTO product, no component parts will be found in this entry, so the system proceeds to step 246, in which the in which the next entry is read. On the other hand, if it is determined in step 244 that the entry which has just been read is not for a CTO product, the entry must be either for a building block within a CTO product or a for a fixed configuration product. In accordance with a preferred version of the present invention, a bill of material 236 (shown in FIG. 3) is provided for each building block and for each fixed configuration product. Thus, following a determination in step 244 that the entry does not describe a CTO product, the system proceeds to step 248, in which the particular bill of material 236 for the building block or fixed configuration product is found. Then, in step 250, the first entry in this bill of material 236 is read.

At this point, it is necessary to identify, within step 252, the supplier from which the component part identified in the most recently read entry from the bill of material 236. If the bill of materials includes a field identifying the supplier for each entry, this information is read with the entry. Otherwise, the part number or other code identifying the component part is compared with a list of suppliers for component parts (not shown) to identify the supplier. Then, in step 254, N is set to zero to begin calculations of the number of the component parts needed for the current week. Then, in step 256, a component demand volume, Q_{C}(N), is calculated as the volume of the component part using the following equation 1 derived from Equations 9) and 10,

Q_{C}(N)=V_{OX}(N)Q_{CX} 11)

where:V_{OX}(N)=V_{OP} (N);Q_{CX} =Q_{CP} if component parts for a fixed configuration product are being considered, and

V_{OX}(N)=V_{OB}(N);Q_{CX}=Q_{CB} if component parts for a building block are being considered.

Then, in step 258, the result of the calculation in step 256 is written in the date array portion of a net demand data structure being prepared for transmission to the supplier identified in step 252.

In step 260, a determination is made of whether N has a value of 12, indicating that the calculation for the last week in the planning cycle have already occurred. If N is not yet 12, N is increased by one in step 262, and the system returns to step 256 to calculate a component demand value for the next week. When N reaches a value of 12, a determination is made in step 264 of whether the entry which has been considered from the bill of materials data structure 236 is the last entry in this data structure 236. If it is not the last entry, the next entry in the bill of materials data structure 236 is read in step 268, so that data may be developed for the next component part listed in the data structure 236, beginning with finding the supplier for this next component part in step 252.

If it is determined in step 264 that the last entry in the bill of material data structure 236 has been read, a determination is made in step 268 of whether the last entry in the net demand data structure 150 has been read. If the last entry has not been yet read, the system proceeds to step 246 to read the next entry. If the last entry in the net demand data structure has been read, the explode process 232, having been completed, ends in step 270.

Thus, the explode process 232 generates a parts demand data structure 234 for each supplier, having a format generally as shown in FIG. 3, with an entry for each type of part to be supplied by the particular supplier, with a first data field indicating the part number or other identifier of each component part to be ordered from the supplier and with a data array having a data field for the current weak and for each of the next 12 weeks, with quantities within this array indicating the volumes of each component part needed during each of the weeks to meet the volumes of the net demand forecast data structure 150.

Referring to FIGS. 1 and 3, the parts demand data structures 234 are preferably sent to the individual suppliers 276 through the Internet server 24, and over the Internet 20, to be received by a supplier system 26. Preferably, each of the parts demand data structures is sent in a form which can be downloaded and modified as a spread sheet to indicate the volume of parts which the supplier is willing to commit to be able to provide for each of the weeks in the planning cycle. When this process of supply assessment is completed by the supplier, it is returned, preferably over the Internet, as a committed parts data structure 280, having the format of the parts demand data structure 234 from which it is derived, with changes to the volumes being made as deemed necessary.

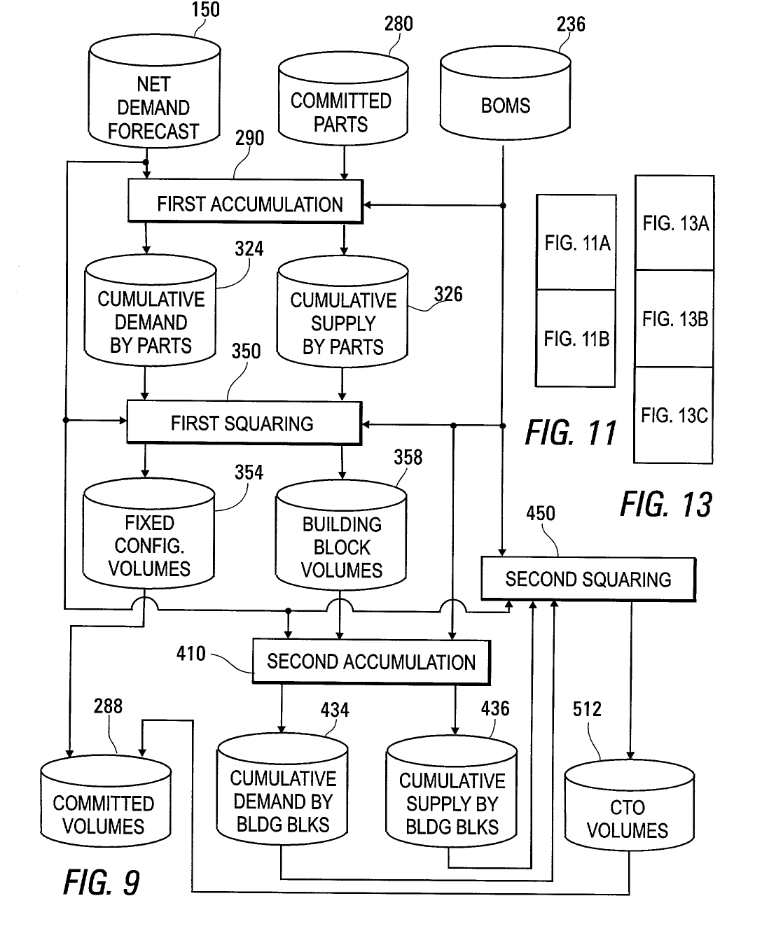

FIG. 9 is a flow chart showing the flow of data within an implode and squaring process 286, through which a committed volumes data structure 288 is generated within the supply chain planning process 230, using an implode and squaring process 286.

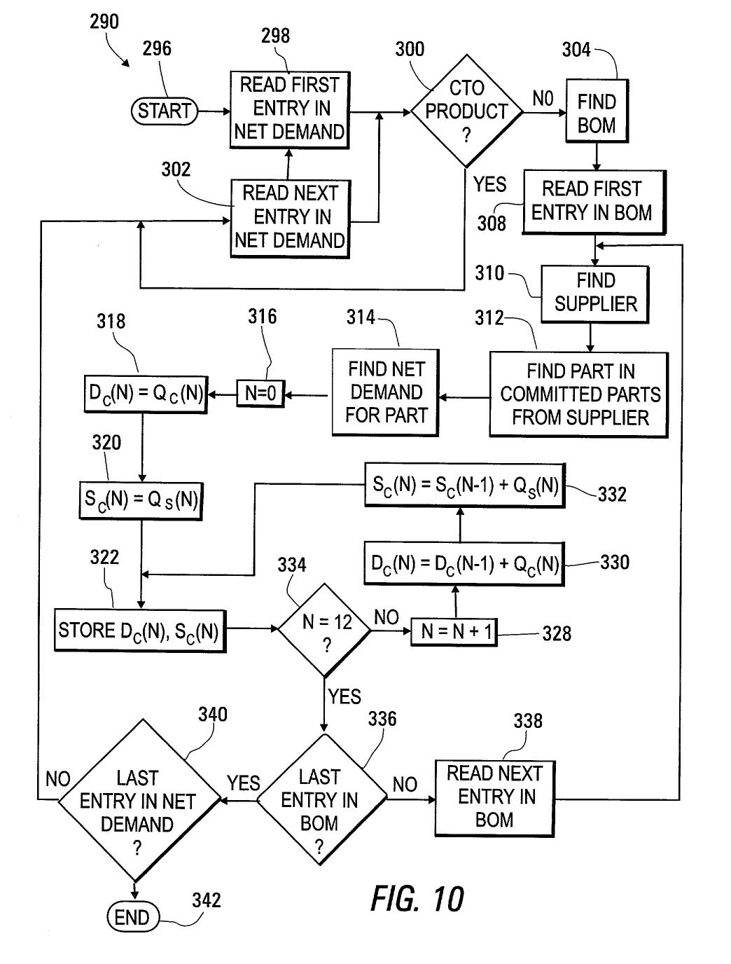

FIG. 10 is a flow chart showing steps occurring within an accumulation process 290 beginning the implosion and squaring process 286. In the accumulation process 290, cumulative demand volumes are generated from the weekly volumes stored in the net demand data structure 150, or alternately from the parts demand by suppliers data structure 254, and cumulative supply volumes are generated from the committed parts data structures 280 received from individual suppliers. The use of cumulative demand volumes is based on an understanding that, if a demand for products is not satisfied in one week due to constraints on the availability of component parts, it remains in place to be satisfied in a subsequent week. The use of cumulative supply volumes is based on an idea that, if available parts cannot be used in one week, they can be used later.

For the current week, in which N has a value of zero, the cumulative demand, D_{C}(N) is given by:

D_{C}(N)=Q_{C}(N) 12)

where Q_{C}(N)=the quantity of a component required to satisfy the net demand forecast, generated by applying Equation 11 to weekly volume data from the net demand forecast data structure 150 or read from the parts demand by suppliers data structure 234 (shown in FIG. 3).

For subsequent weeks in the planning cycle the demand volumes are accumulated by adding the cumulative demand from the previous week to the quantity of the component required in the net demand forecast, so that the cumulative demand is given by:

D_{C}(N)=D_{C}(N−1)+Q_{C}(N) 13)

Similarly, for the current week, in which N has a value of zero, the cumulative supply, S_{C}(N) is given by:

S_{C}(N)=Q_{S}(N) 14)

where Q_{S}(N)=the quantity of a component committed by its supplier, read from the committed parts data structure 280.

For subsequent weeks in the planning cycle the supply volumes are accumulated by adding the cumulative supply from the previous week to the quantity of the component committed by its supplier, so that the cumulative supply is given by:

S_{C}(N)=S_{C}(N−1)+Q_{S}(N) 15)

Referring to FIGS. 9 and 10, after the first accumulation process 290 is started in step 296, the first entry of the net demand forecast data structure is read in step 298. While this data structure 150 does not include data at the level of component parts, as needed in this first accumulation process 290, it is used to provide a complete list of the bill of material data structures 236 for both fixed configuration products and for the building blocks needed in CTO products. After each entry within the net demand data structure 150 is read, a determination is made in step 300 of whether the entry defines a CTO product. If it does, it includes no description of building blocks, which are instead listed in one or more of the next entries, so the next entry is read in step 302. Then, in step 304, the bill of material data structure 236, for the fixed configuration product or building block described in the line last read in step 300 or 302, is found. Then, in step 306. the first entry in this data structure 236 is read to find information identifying a component part, such as a part number. If the supplier is also identified within this entry, this information is also read, to be used in step 310 for finding the supplier. Otherwise, the information identifying the component part is used in step 310 to find a supplier in a data structure (not shown) identifying suppliers of component parts.

Then, in step 312, the component part from the entry last read in the bill of materials data structure 236 is found in the committed parts data structure 280 from the supplier found in step 310, and the entry for this part is read. This entry identifies the component part and provides a committed supply volume, Q_{S}(N), of the component part which the supplier has indicated that he can provide for each of the 12 weeks of the planning period (i.e. for each value of N from 0 to 12).

Next, in step 314, the net demand for the component part is found, preferably by applying data from the net demand forecast data structure 150 and from the bill of material data structure 236 to Equation 9) for a configure to order product or to Equation 10 for a building block. Alternately, the net demand for the component part may be read from the parts demand data structure 234 (shown in FIG. 3) generated for the supplier found in step 310. Like the committed supply volume, the net demand is a function of the week in the planning cycle, with N ranging from 0 to 12.

Next, in step 316, N is set to a value of zero to consider the planned supply and demand for the current week, with Equation 12) being used to derive a value for the cumulative demand in step 318, and with Equation 14) being used to derive a value for the cumulative supply in step 320. Then, in step 322, this value for cumulative demand is stored in a cumulative demand by parts data structure 324, and the value for cumulative supply is stored in the cumulative supply by parts data structure 326. Then, the process for calculating cumulative demand and supply values is continued for each value of N from 1 to 12, as incremented in step 328, with the data being applied to Equation 13) in step 330 and to Equation 15) in step 332, and with each the resulting values being stored in step 322 in a data array, similar to the data array 86 (shown in FIG. 5), within the data structures 324 and 326. When this process is completed, as indicated in step 334 by the values for the last week of the planning period having been stored in step 322, the system proceeds to step 336, in which a determination is made of whether the last entry in the bill ov material data structure 236 has been read. If it has not yet been read, the next such entry is read in step 338, and the system returns to step 310 to find the supplier for the component part identified in the next entry of the bill of material data structure 236.

After the last entry in the bill of material data structure has been read, as determined in step 336, the system proceeds to step 340, in which a determination is made of whether the last entry in the net demand data structure 150 has been read. If the last entry has not been read, the system proceeds to step 302, in which the next such entry is read. If the last such entry has been read, the first accumulation process 290 is finished, ending in step 342.

Continuing to refer to FIG. 9, after the first accumulation process 290 is completed, the first implosion and squaring process 350 is begun. The implosion and squaring process 350 is used to develop a fixed configuration volumes data structure 354 including entries listing the volumes of fixed configuration products that can be built using the parts volumes committed by suppliers, as read from the committed parts data structure 280. Similarly, the implosion and squaring process 350 is additionally used to develop a fixed configuration volumes data structure 358 including entries listing the volumes of fixed configuration products that can be built using the parts volumes committed by suppliers. Cumulative demand data from data structure 324.

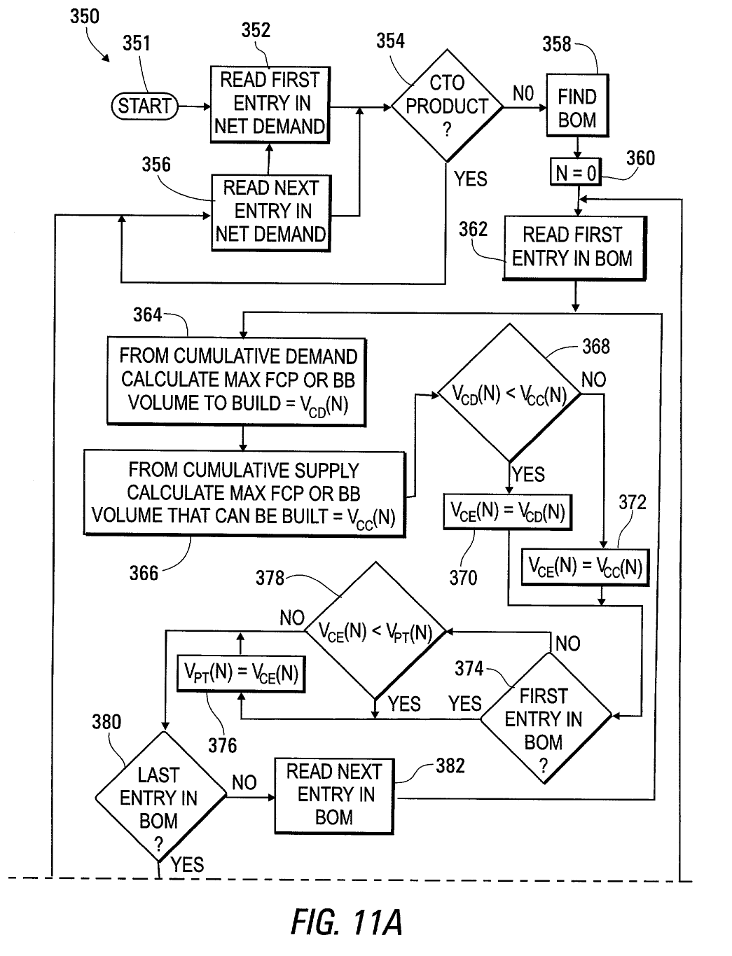

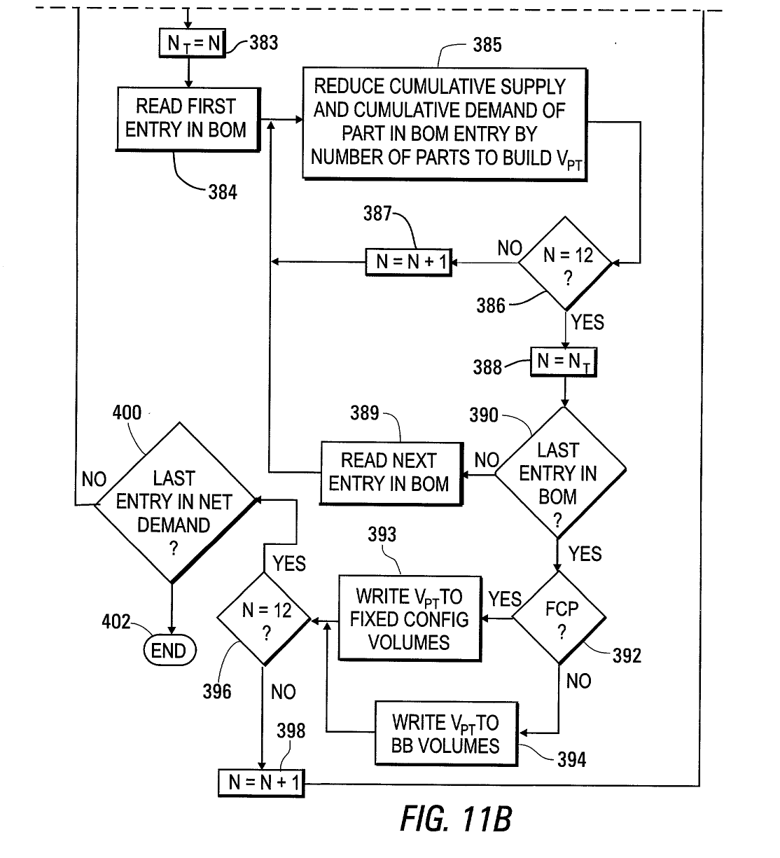

FIG. 11 is a flow chart of steps occurring during the implosion and squaring process 350. FIG. 11A is an upper portion of FIG. 11, while FIG. 11B is a lower portion thereof. After the implosion and squaring process 350 is started in step 351, the first entry in the net demand data structure 150 is read in step 352. Again, if this entry identifies a CTO product, as determined in step 354, since a building block is not listed in the entry itself, the entry which has just been read is skipped to read the next entry in step 356. Other types of entries within the data structure 150 identify either fixed configuration products or building blocks for CTO products, both of which form subjects for the implosion and squaring process 350. Thus, in step 358, the bill of material data structure 236 for the fixed configuration product or building block identified in the entry last read in step 352 or 356 is found.

Next, in step 364. the cumulative demand data structure 324 is searched to find a cumulative demand volume associated with the component part identified in the last entry read from the bill of materials data structure 236. Then, the maximum volume, V_{CD}(N), of the fixed configuration product or building block which can be built to meet the cumulative demand for the particular component part is calculated according to the following equation:

$${V}_{CD} ( N ) = \frac{{D}_{C} ( N )}{{Q}_{CX}} \qquad 16 )$$

where Q_{CX}=the quantity of the component part required in each fixed configuration product or building block, from a bill of material data base 236, and

V_{CX}(N)=the cumulative demand for the component part, from the cumulative demand by parts data base 324.

Next, in step 366, the cumulative supply data structure 326 is similarly searched to find a cumulative supply volume associated with the component part identified in the last entry read from the bill of materials data structure 236. Then, the maximum volume, V_{CC}(N), of the fixed configuration product or building block which can be built using the available volume of this component part is calculated as:

$${V}_{CC} ( N ) = \frac{{S}_{C} ( N )}{{Q}_{CX}} \qquad 16 )$$

where S_{C}(N)=the cumulative supply for the component part, from the cumulative supply by parts data base 326.

The actual volume of the fixed configuration product or building block during the week identified by the value of N may be limited by the data associated with this particular component part, as calculated most recently in steps 364 and 366, or by data associated with another component part described in the bill of materials data structure 236. If it is limited by this particular component part, it may be limited by the cumulative supply or by the cumulative demand. Therefore, comparisons are made to determine the actual limiting factor. First, in step 368, a determination is made of whether the volume projected using the available demand is less than the volume projected using the available supply. If the volume projected using the available demand is the lesser value, this volume is set, in step 370, as the volume constrained by the part associated with this entry in the bill of materials data structure 236. Otherwise, the volume projected using the supply is set as this constrained volume in step 372. If it is determined in step 374 that the bill of materials entry for which calculations are being considered is the first entry, a total constrained volume, V_{PT}, is set at the level of constrained volume for this component part in step 376. For each subsequent, entry, this total constrained volume is changed to the level calculated for the entry only if it is determined in step 378 that the value calculated for the entry is less than the stored level of the total constrained value. In this way, after each entry in the bill of materials data structure 236 has been considered, the total constrained volume remains at the lowest level calculated for the particular bill of materials data structure from which entries are being considered.

Thus, in step 380, after the completion of the comparisons of calculated constrained volume levels, a determination is made of whether the last entry in the bill of materials data structure 236 has been considered. If it has not yet been considered, the next entry in this data structure 236 is read in step 382. The system then returns to step 362 to begin the process of calculating constrained volumes associated with the next component part listed in this data structure 236.

If it is determined in step 380 that the last entry in the bill of material data structure 236 has been read, the system proceeds to step 383, in which a new variable, N_{T}, is set to the present value of N, so that the present value of N can be regained after N is incremented to provide for the recalculation of cumulative supply and demand values. Next, in step 384, the first entry in the data structure 236 is read again to begin a process of subtracting a volume of component parts which would be used to produce fixed configuration products or building blocks equal to the total constrained value, V_{PT}, for the week identified by the current value of N. This process assumes that, during this week, this volume of fixed configuration products of building blocks will be built, and that in this way, both the cumulative demand and the cumulative supply will be reduced correspondingly. Thus, for each entry in the bill of material data structure 236, the cumulative values for demand and supply are reduced in step 385 by the number of parts required to build V_{PT} fixed configuration products or building blocks.

Because the cumulative supply and demand values are in fact cumulative, a reduction in these values must also be reflected by a similar change in these values for weeks within the planning cycle following the week identified by N. Therefore, until the calculation has been made for the last week in the planning cycle, as determined in step 386, the value of N is incremented in step 387, with the reduction in values within each week occurring in step 385. Then, in step 388, the value of N_{T} is returned to N.

The next entry in the data structure 236 is then read in step 389 until it is determined in step 390 that the last entry in the bill of material data structure 236 has been read. In each instance, the number of parts required to build the fixed configuration products or building blocks is found by multiplying V_{PT} by the quantity of parts required to build a fixed configuration product or building block, in the manner of Equation 11).

Afer a determination is made in step 390 that the last entry in the bill of material data structure 236 has been read, the system proceeds to step 392, in which a determination is made of whether the bill of material data structure 236 is for a fixed configuration product. If it is, the value of the total constrained volume, V_{PT}, is written to the fixed configuration volumes data structure 354 in step 393. Otherwise, the bill of material data structure 236 is known to be for a building block, so the value of the total constrained volume, V_{PT}, is written to the building block volumes data structure 358 in step 394. This process leaves a squared volume of the fixed configuration product or building block being planned to be built to satisfy the cumulative demand without exceeding the cumulative supply of components, as constrained by the committed parts data structure 290.

After data is written in step 392 or 394, a determination is made in step 396 of whether data for the last week of the planning period, indicated by a value of 12 for N, has been written. If it has not, a value of one is added to the value of N in step 398, and the system returns to step 360 to begin the process explained above for the next week. If it is determined in step 396 that data for the last week has been written, the system proceeds to step 400, in which a determination is made of whether the last entry in the net demand forecast data structure 150 has been read. If it has not been read, the system returns to step 356 to read the next such entry. If the last such entry has been read, it is known that the first implosion and squaring process 350 has been completed, so this process ends in step 402, with both the fixed configuration volumes data structure 354 and the building blocks data structure 358 being structured in the format shown in FIG. 3, having been filled with squared volumes for each of the weeks of the planning cycle.

Continuing to refer to FIG. 9, the completion of the first implosion and squaring process 350 completes the process of squaring component orders for fixed configuration products but not for CTO products, because having component parts available for the various building blocks as soon as possible according to the net demand forecast data structure 150 does not mean that the building blocks can be used, as their components become available, to in turn build rational CTO products. In the development of the building block volumes data structure 358, constraints on the availability of component parts have been placed on the parts needed for individual building blocks, not on the combinations of building blocks needed to build rational CTO products.

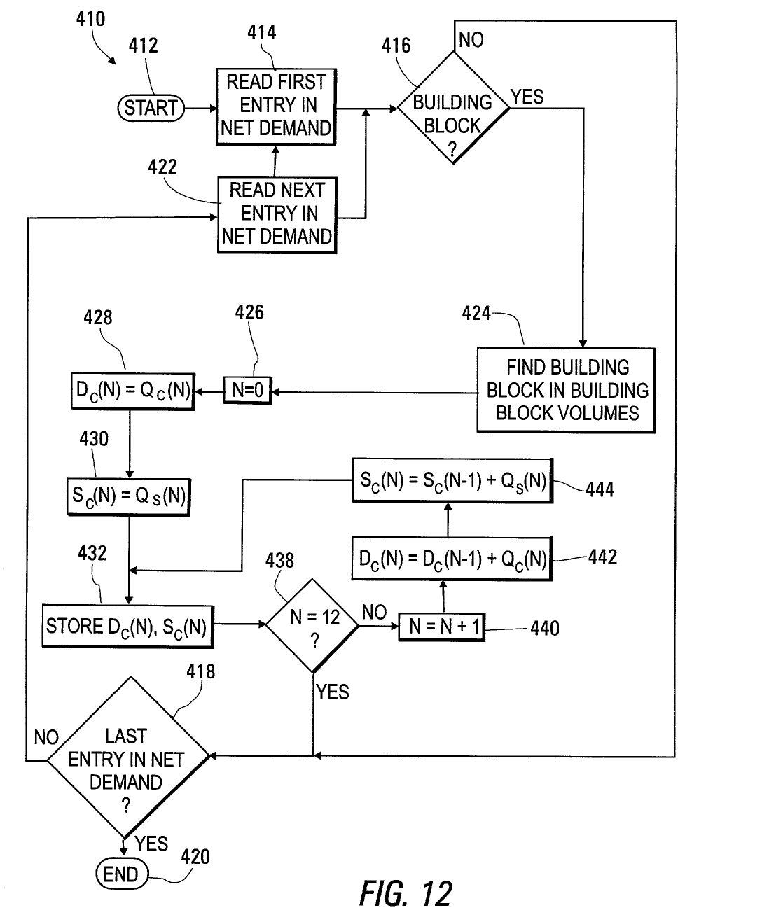

FIG. 12 is a flow chart of a second accumulation process 410 occurring during the implode and squaring process 286. In this second accumulation process 410, weekly volumes for demand are again read from the net demand forecast data structure 150, while weekly volumes for the available supply of building blocks are read from the building block volumes data structure 358. After the second accumulation process 410 is started in step 412, the first entry of the net demand forecast data structure 150 is read in step 414. Since this process is only concerned with generating data for building blocks, any entry not describing a building block, as determined in step 416 is skipped, with a determination being made in step 418 that it is not the last entry in the net demand forecast data structure 150. If it is the last entry, the process ends in step 420; otherwise the system proceeds to step 422, in which the next entry in the net demand forecast data structure 150 is read.

Continuing to refer to FIGS. 9 and 12, if it is determined in step 416 that an entry for a building block has been read, the system proceeds to step 424, in which an entry within the building block volumes data structure 358 is read to determine the weekly volumes for the building block. Then, in step 426, the value of N is set at zero to proceed with calculations for the current week. Next, in step 428, the quantity of the building block to satisfy the net demand during the current week, from the net demand forecast data structure 150, is applied to Equation 12). In step 430, the quantity of the building block for the current week, from the building block volumes data structure 358 is applied to Equation 14). Then, in step 432, the resulting cumulative values for demand and supply are stored in the cumulative demand by building blocks data structure 434 and the cumulative supply by building blocks data structure 436, respectively.

After data is stored in these data structures 434, 436, a determination is made in step 438 of whether data has been stored for the last week of the planning process. If it has not, a value of one is added to N in step 440, with the quantity of the building block required to satisfy the net demand during the week identified by N being applied to equation 13) in step 442, and with the quantity for this week from the building block volumes data structure 358 being applied to Equation 15) in step 444. Then, the system returns to step 432 to record the calculated values in the data structures 434 and 436. When a determination is made in step 438 that data has been stored for the last week in the planning cycle, the system returns to step 418, to read the next entry from the net demand data structure 150, or to end the second accumulation process 410 in step 420 if the last such entry has been read.

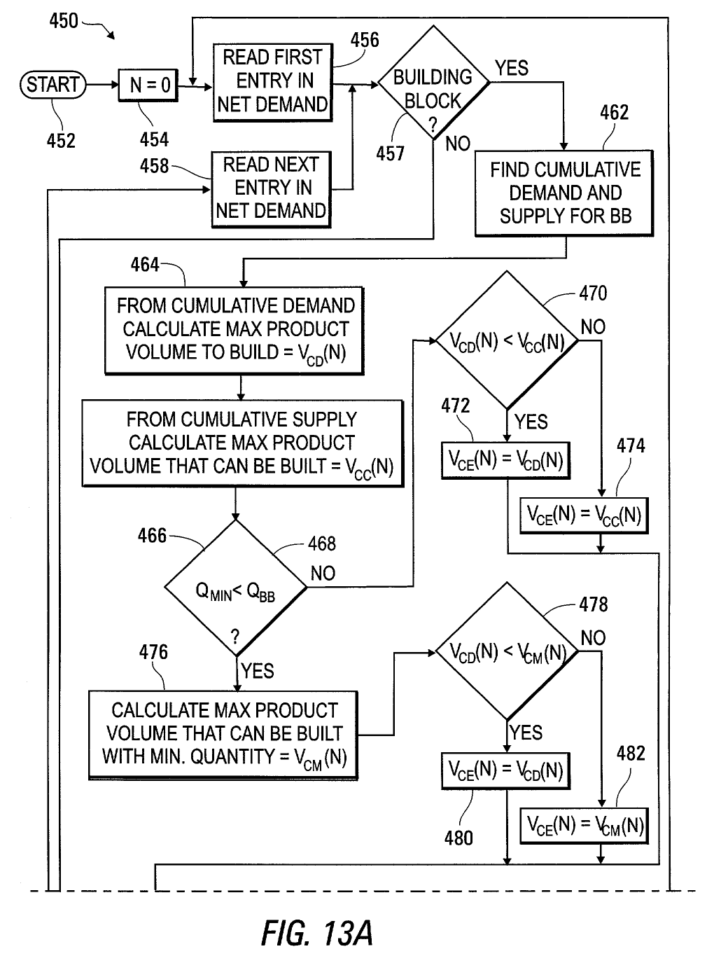

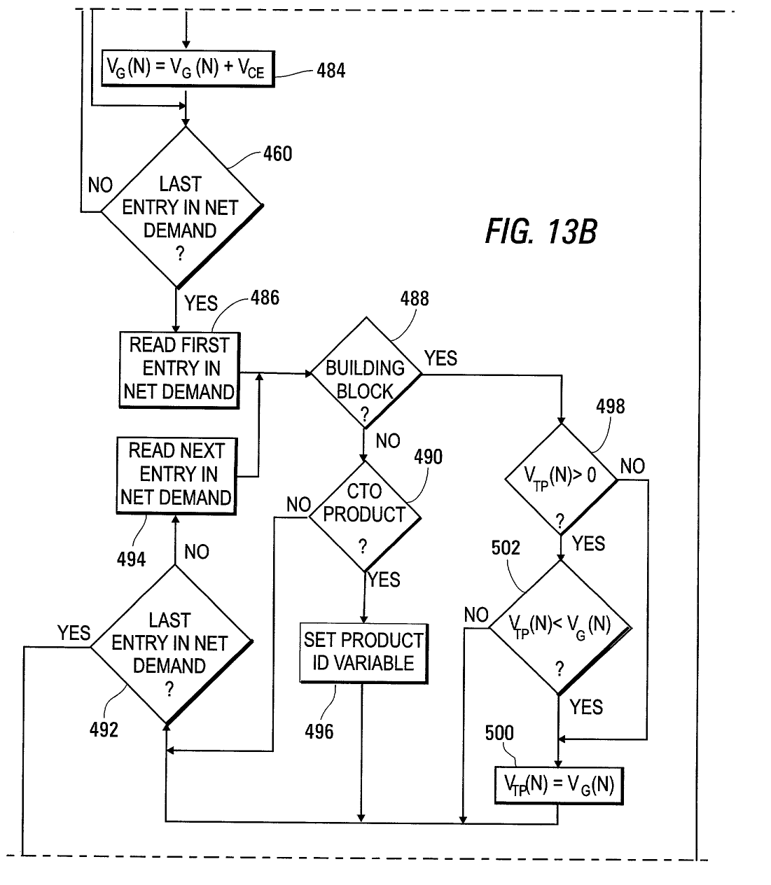

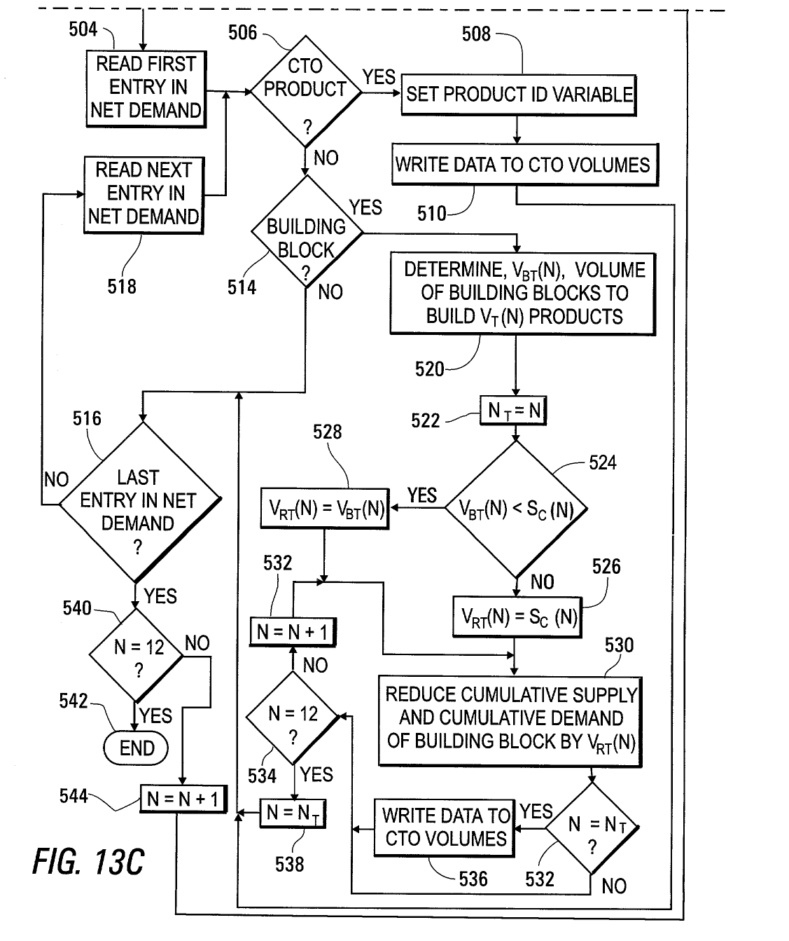

FIG. 13 is a flow chart of processes occurring during the second squaring process 450 (shown in FIG. 9). FIG. 13 includes an upper portion, designated as FIG. 13A, a central portion, designated as FIG. 13B, and a lower portion, designated as FIG. 13C.

Referring to FIGS. 9 and 13, after the second squaring process 450 is started in step 452, the value of N is set to zero in step 454. Next, the first entry in the net demand data structure 150 is read in step 456. Since this second squaring process is only concerned with building blocks in the net demand data structure 150, each time an entry from this data structure 150 is read, as determined in step 457, the system skips this entry, reading the next entry in step 458 after determining in step 460 that the entry just read is not the last entry in the data structure 150.

After it is determined in step 457 that an entry for a building block has been read, the system proceeds to step 462, in which a corresponding value for cumulative demand is read from the cumulative demand by building blocks data structure 434, and in which a corresponding value for cumulative supply is read from the cumulative supply by building blocks data structure 436. Then, in step 464, the volume of products which can be built satisfying this level of cumulative demand is calculated, dividing the cumulative demand by the quantity of the building block per product, taken from its bill of material data structure 236. Next, in step 466, the volume of products that can be built with the cumulative supply of the building block is calculated, dividing the cumulative supply by the quantity of the building block per product.

As described above in reference to FIG. 5, each entry for a building block in the demand forecast data structure 140 and, hence, in the net demand data structure 150 includes a minimum quantity, Q_{MIN}, of the building block needed per product. In step 468, this value is compared to a quantity of the building block, Q_{BB}, per product, according to the attach rate. If Q_{MIN} is the smaller quantity, as determined in step 468, the number of products that can be built using this building block is limited by either this minimum quantity, Q_{MIN}, or by the cumulative demand. Otherwise, the number of products that can be built is limited either by the cumulative supply or by the cumulative demand. Thus, if it is determined in step 468 that Q_{MIN} is not the smaller quantity, the volume of products to be built with the cumulative demand volume is compared in step 470 to the volume of products to be built with the cumulative supply volume, with a constrained product volume associated with this building block, V_{CE}(N) being set to the lower of these volumes in one of the subsequent steps 472, 474.

On the other hand, if it is determined in step 468 that Q_{MIN} is the smaller quantity, a minimum volume of products, V_{CH}(N), that can be with to the minimum quantity per product, Q_{MIN}, is calculated in step 476. If Q_{MIN} is zero, a large number is substituted for this result. This minimum volume of products is then compared in step 478 to the volume of products to be built with the cumulative supply volume, with a constrained product volume associated with this building block, V_{CE}(N) being set to the lower of these volumes in one of the subsequent steps 480, 482.

As further described above in reference to FIG. 5, each building block is a part of a group. If there is only one building block in a group the problem volume limitation of that building block is the volume limitation of the group. If there are multiple building blocks in a group, the volume limitations of the multiple building blocks are added to arrive at the volume limitation of the group. Since each of the CTO products must include each group of which it is composed, the group having the lowest volume limitation becomes the volume limitation of the product. Thus, after the constrained volume for the product due to a building block, V_{CE}(N) is calculated as described above, its value is added to the volume constraint of the group, V_{G}(N), in step 484.

Then, in step 460, a determination is made of whether the last entry in the net demand data structure 150 has been read. If the last entry has not been read, the system returns to step 458 to read the next such entry. If the last entry has been read, it is understood that a volume constraint for each group has been calculated for the week identified by N, so the system proceeds to determine a constrained volume for the CTO product, V_{TP}(N), according to the smallest of the constrained volumes for the groups, V_{G}(N). The process of this determination begins in step 486, with the first entry of the net demand forecast data structure 150 being read again. Each time such an entry from the net demand data structure 150 is read, a determination is made, in step 488, of whether the entry is for a building block. If it is not, a determination is made in step 490 of whether the entry describes a CTO product. If it is not, a determination is next made, in step 492 the last entry has not been read, before the next entry is read in step 494.

After it is determined in step 490 that the entry most recently read in step 486 or 494 is for a CTO product, a product-identifying variable is set, in step 496, to a value identifying the new product. This is based on the concept, described above in reference to FIG. 3, that, within the net demand forecast database 150, an entry identifying a CTO product is followed by entries describing the building blocks comprising the CTO product. The product-identifying variable set in step 496 establishes the product for which volumes will be calculated.

After it is determined in step 488 that the entry most recently read in step 486 or 494 is for a building block, a determination is made in step 498 of whether V_{TP}(N) is greater than zero. If it is not greater than zero, it is understood that the entry that has just been read is the first building block entry for a particular CTO product, so the value of V_{TP} is set in step 500 to the value, V_{G}(N), for the building block described in the most recently read entry. If the value of V_{TR}(N) is determined in step 498 to be greater than zero, the value of V_{TR}(N) is set to the value of V_{G}(N) following a determination in step 502 that V_{TR}(N) is not less than V_{G}(N). In this way, the value of V_{TR}(N) is driven to the lowest value of V_{G}(N) for each CTO product.

After the product-identifying variable is set in step 496, or after the processes described above for calculations following reading a building block variable in steps 486, 494, the system returns to step 492 to determine whether entry most recently read is the last entry in the net demand forecast data structure 150. If it is not the last entry, the next entry is read in step 494. If it is the last entry, the system proceeds to step 504, in which the first entry in the net demand data structure 150 is again read.

If the entry describes a CTO product, as determined in step 506, the product-identifying variable is set in step 508 to a value identifying the new CTO product. Then, in step 510, data describing the CTO product is written to the CTO volumes data structure 512, with this data including an entry having a value of V_{TR}(N) in the data field for the week identified by N. After step 510, and additionally if the entry read from the net demand forecast data structure 150 is neither a CTO product nor a building block, as determined in steps 506 and 514, the system proceeds to step 516, from which, following a determination that the entry is not the last entry in the net demand forecast data structure 150, the system proceeds to step 518 to read the next such entry.

When a building block entry has been read, as determined in step 514, the volume of the building block, V_{BT}(N) used to build the previously determined number of products, V_{TP}(N), is calculated in step 520. Then, in step 522, a variable N_{T} is set to the value of N so that this value can be recovered later. Next, in step 524, a determination is made of whether the volume of building blocks, V_{BT}(N) is less that the available cumulative supply of the building block. If the required quantity of the building block is less than the quantity otherwise specified, products can be made even through a supply of the building block is not available. Therefore, if it is determined in step 524 that the supply is less than the volume specified, a volume of the building block to be used, V_{RT}(N), is reduced by the available supply in step 526. If the specified volume of building blocks is less than the available supply, the volume of the building block to be used, V_{RT}(N), is set to the specified volume of building blocks in step 528. In either case, the cumulative supply volume in the data structure 436 and the cumulative demand volume in the data structure 434 are reduced by the value of V_{RT}(N) in step 530.

Because of the cumulative nature of the cumulative supply and demand volumes, these values for weeks beyond the week identified by N must be similarly reduced. This is done by repeating step 530, with N being incremented by one in step 532, until it is determined in step 534 that data for the last week has been calculated. On the first such pass through step 530, when N still has a value of N_{T}, as determined in step 532, data for the building block is written in step 536 to the CTO volumes data structure 512, with the volume of the building block to be used, V_{RT}, being written to the corresponding space within the data array for the week N.

After a determination is made in step 534 that data has been corrected in step 530 for the last week within the planning cycle, N is reset to N_{T} in step 538, returning to the value of N before incrementing in step 532. Then, a determination is made in step 516 of whether the last entry in the net demand data structure 150 has been read. If it has not yet been read, the system returns to step 518 to read the next such entry. If the last entry has been read, a determination is made in step 540 of whether calculations have been completed for the last week in the planning cycle. If they have, the second squaring process 450 ends in step 542. Otherwise, the value of N is incremented in step 544, and the system returns to step 456 to begin calculations for the next week in the planning cycle.

Continuing to refer to FIG. 9, the contents of the fixed configuration data structure 472 and the CTO volumes data structure 512 are transferred to the committed volumes data structure 288, providing a listing of the products and building blocks to be ordered within each week of the planning cycle, as constrained by both the demand and the supply, with the supply being based on committed volumes from suppliers.

Referring again to FIG. 3, the supply chain planning process 230 has been described as occurring according to an automatic, predetermined method. According to a preferred version of the present invention, while such a method is provided, particular means are additionally provided for interaction with a user, including both providing data to the user through a user interface 550 and accepting a user input 552 to modify the process. Preferably, the process 230 provides for information to be displayed and for changes to be made during its operation. For example, the first and second accumulation processes have been arranged to develop information that can be displayed to gain a view of the available supply of components and building blocks over the entire planning cycle. If this view is not needed, by calculating the cumulative supply and demand, together with the components or building blocks to be used with squaring, on a weekly basis, with the components or building blocks to be used subtracted from the cumulative supply and demand for the next week.

After the supply chain planning process 230 is completed, the committed volumes data structure 288 is provided as an input to an allocation planning process 554, in which the volumes of fixed configuration products and CTO products are divided among the various customers. The allocation planning process then provides a committed volumes arranged by customers data structure 556 as an input to the fulfillment process 90. The fulfillment process 90 then transmits responses 558 to customers 94. The customers 94 then place customer orders 92 for the products indicated as available in the various weeks of the planning process.

The committed volumes data structure 288 is also provided as an input to a demand finalizing process 560 within demand planning 60. The demand finalizing process 560 generates an execution volumes data structure 562, which is provided as an input to enterprise requirements planning 564, which in turn generates orders 566 sent to suppliers 276 for various components. In this process, the demand planning process 60 works with fixed configuration products, CTO products, and building blocks, as included within the committed volumes data structure 288 and in the execution volumes data structure 562. That is, the demand planning process 60 does not explicitly work with the individual components making up the various fixed configuration products and CTO products. Therefore, the enterprise requirements planning process 564 also uses inputs from the bill of materials data structure 236 to derive a list of component parts to place orders for the products and building blocks in the execution volumes data structure 562. As orders are placed with suppliers, the enterprise planning process 564 also updates information on the products and building blocks on order, as stored within the supplier order log data structure 128.

In accordance with a preferred version of the present invention, while the squaring process described above is used to provide an input to the allocation planning process 554, the demand finalizing process 560 follows the net demand forecast data structure 150, which is available to the demand planning process 60, more closely than the committed volumes data structure 288. Thus, the subsequently generated orders 566 to suppliers 276 include orders for components included in unsquared volumes of products and building blocks. In this way flexibility is maintained for meeting future customer orders if supply problems can be resolved. The user interface 130 of the demand planning process 60 is preferably available to provide data to a system user and to accept user inputs 132 to modify the demand finalizing process 560.

Preferably, the various portions of the planning process described above are scheduled to occur during predetermined portions of each week, with, for example, the demand forecast netting process 156 taking place Monday morning, with the supply chain planning 236, including collaboration with suppliers 276, taking place Monday afternoon through Wednesday afternoon, with a supply position being determined on Thursday, along with the generation of the committed volumes data structure 288, and with allocation planning 554 occurring on Friday, along with enterprise requirements planning 564 and the generation of orders to suppliers 566. This kind of schedule provides time for several iterations of collaboration with the suppliers 226, which may be required to reach satisfactory levels of committed component parts. The various activities, such as demand planning 60, supply chain planning 230, enterprise requirements planning 564, and allocation planning 554, may be carried out in the same computer system at different times or in a number of computer systems interconnected to provide for the transmission of data structures.

While a preferred version of the invention has been described with some degree of particularity, it is understood that this description has been given by way of example, and that many changes can be made without departing from the spirit and scope of the invention as defined by the appended claims.

What is claimed is:

1. A system for planning ordering of components for a plurality of products comprising:
communication means for communicating over a computer network; data storage storing
a demand forecast data structure storing data describing volumes of components for products within said plurality thereof expected to be required during time periods within a plurality of time periods,
a customer order log data structure storing data describing orders placed by customers over said computer network for products within said plurality thereof for said time periods,
a supplier order log data structure storing data describing orders placed with suppliers for components of said products,
a net demand forecast data structure describing volumes of said components remaining to be ordered for said time periods,
a committed parts data structure storing data describing volumes of said components committed over said computer network by suppliers of said components to be supplied for said time periods, and
a committed volumes data structure storing data describing volumes of said products which can be built with volumes of said components within said committed parts data structure; and processor means programmed to
determine volumes of said components to be stored in said net demand forecast data structure for said time periods by subtracting volumes of components from said supplier order backlog data structure from volumes of components within said demand forecast data structure,
prepare data from said net demand data structure for said time periods for transmission to suppliers of said components, and
determine, for storage of data in said committed volumes data structure, volumes of said products to be built for said time periods with components for which data is stored in said committed parts data structure.

2. The system of claim 1, wherein said plurality of time periods includes a present time period and a number of sequential future time periods.

3. The system of claim 1, wherein
said plurality of products includes a configure-to-order product, and
said orders placed by customers include configuration specifications for said configure-to-order product.

4. The system of claim 3, wherein
said data storage additionally stores a bill of materials data structure,
said bill of materials data structure includes a plurality of building block data structures,
each building block data structure in said plurality of building block data structures includes data describing a portion of components required to build a configuration of said configure-to-order product,
said configure-to-order product includes components described in a number of said building block data structures.

5. The system of claim 4, wherein
said data describing volumes of components in said demand forecast data structure and in said net demand forecast data structure includes data identifying said building block data structures, and
said processor means is additionally programmed to:
determine component requirements from said building block data structures in said bill of materials data structure in preparing data from said net demand data structure for said time periods for transmission to suppliers of said components, and
determine a volume of said configure-to-order product to be built from said building block data structures in said bill of materials data structure in determining, for storage of data in said committed volumes data structure, volumes of said products to be built for said time periods with components for which data is stored in said committed parts data structure.

6. The system of claim 5, wherein
said plurality of products additionally includes a fixed configuration product,
said bill of materials data structure additionally includes a product data structure including data describing components required to build said fixed configuration product,
said data describing volumes of components in said demand forecast data structure and in said net demand forecast data structure includes data identifying said product data structure, and
said processor means is additionally programmed to:
determine component requirements from said product data structure in said bill of materials data structure in preparing data from said net demand data structure for said time periods for transmission to suppliers of said components, and
determine a volume of said fixed demand product to be built from said product data structure in said bill of materials data structure in determining, for storage of data in said committed volumes data structure, volumes of said products to be built for said time periods with components for which data is stored in said committed parts data structure.

7. The system of claim 6, wherein said data describing volumes of products stored in said committed volumes data structure includes data identifying a product data structure describing said fixed configuration product and data describing building block data structures describing said configure-to-order product.

8. The system of claim 1, wherein
said plurality of products includes a plurality of fixed configuration products,
said data storage additionally includes a bill of material data structure,
said bill of materials data structure includes a product data structure having data describing components required to build said fixed configuration product for each fixed configuration product in said plurality of fixed configuration products, and
said processor means is additionally programmed to:
determine component requirements from each said product data structure in said bill of materials data structure in preparing data from said net demand data structure for said time periods for transmission to suppliers of said components, and
determine a volume of each said fixed demand product to be built from said product data structure in said bill of materials data structure in determining, for storage of data in said committed volumes data structure, volumes of said products to be built for said time periods with components for which data is stored in said committed parts data structure.

9. The system of claim 1, wherein said processor means resides in a single computer system.

10. The system of claim 1, wherein said processor means resides in a plurality of computer system connected to transmit data to one another.

11. The system of claim 1, wherein said processor means is additionally programmed to determine from said committed volumes data structure whether a product ordered by a customer for a specific time period is available within said specific time period.

12. The system of claim 11, wherein
said data storage additionally stores a committed volumes by customer data structure, and
said processor means is additionally programmed to store data in said committed volumes by customer data structure in response to a determination that said product ordered by a customer for a specific time period is available within said specific time period.

13. The system of claim 12, wherein said processor means is additionally programmed to notify a customer that an order is confirmed in response to said determination that said product ordered by a customer for a specific time period is available within said specific time period.

14. The system of claim 1, additionally comprising a display and a selection device, wherein said processor means is additionally programmed to:
cause data representing said data structures to be displayed, and
accept inputs from said selection device to change data in said data structures.

15. The system of claim 1, wherein
said data storage additionally stores an execution volumes data structure describing volumes of said components to be ordered for said time periods, and
said processor means is additionally programmed
to store data in said execution volumes data structure, and
to generate orders to suppliers for volumes of said components described in said execution volumes data structure.

16. The system of claim 15, wherein
said plurality of products include a configure-to-order product and a fixed configuration product
said orders placed by customers include configuration specifications for said configure-to-order product,
said data storage additionally stores a bill of materials data structure,
said bill of materials data structure includes a plurality of building block data structures and a product data structure.
each building block data structure in said plurality of building block data structures includes data describing a portion of components required to build a configuration of said configure-to-order product,
said configure-to-order product includes components described in a number of said building block data structures,
said product data structure includes data describing components required to build said fixed configuration product, and
said processor means is additionally programmed to determine components to be ordered from data stored in said bill of materials data base and said execution volumes data structure.

17. Data storage having recorded thereon computer readable data for use in a process ordering component parts for fixed configuration products and for configure-to-order products, wherein
said computer readable data comprises a plurality of product data structures, a plurality of building block data structures, and a planning data structure for storing data used in planning, wherein
each product data structure in said plurality of product data structures includes entries listing each component part within a fixed configuration product associated with said product data structure and a quantity of said component part within said fixed configuration product associated with said product data structure,
each building block data structure in said plurality of building block data structures includes entries describing component parts associated with said building block data structure forming a portion of a configure-to-order product and a quantity of said component part within said portion of said configure-to-order part,
each of said configure-to-order products includes component parts within a number of building block data structures in said plurality of building block data structures, and
said planning data structure includes:
a plurality of fixed-configuration product entries identifying a product data structure in said plurality of product data structures;
a plurality of configure-to-order entries identifying a configure-to-order product; and
a plurality of building bock entries associated with each of said configure-to-order entries, wherein each of said building block entries identifies a building block data structure in said plurality of building block data structures, and wherein said component parts described in said building block data structure are used within a version of said configure-to-order product.

18. The data storage of claim 17, wherein said plurality of building block entries are associated with said configure-to-order product entry by being disposed in an uninterrupted sequence of entries directly following said configure-to-order product entry.

19. The data storage of claim 18, wherein
said planning data structure includes a data field identifying an attach rate within each said building block entry, and
said attach rate represents a planned portion of said configure-to-order products including components described in said building block data structure identified within said building block entry.

20. The data storage of claim 19, wherein
said planning data structure additionally includes a data field identifying a minimum quantity within each said building block entry, and
said minimum quantity represents a minimum quantity of said components described in said building block data structure identified within said building block entry to be included within said configure-to-order product.

21. The data storage of claim 17, wherein
said planning data structure includes a plurality of planning volume data fields,
each planning volume data field in said plurality of planning volume data fields is associated with a time period in a plurality of sequential time periods,
each planning volume data field in said plurality of planning volume data fields includes, in each fixed-configuration product entry in said plurality of fixed-configuration product entries, a number representing a planned volume of said fixed-configuration product for said time period associated with said planning volume data field, and, in each configure-to-order product entry, a number representing a planned volume of said configure-to-order product for said time period associated with said planning volume data field.

22. The data storage of claim 21, wherein each planning volume in said plurality of planning volumes includes, in each said building block entry, a number representing a planned volume of said components identified in said building block data entry identified in said building block entry for said time period associated with said planning volume data field.

23. The data storage of claim 22, wherein
said planning data structure includes an attach rate data field identifying an attach rate within each said building block entry,
said attach rate represents a planned portion of said configure-to-order products including components described in said building block data structure identified within said building block entry, and
each said number representing a planned volume in each said building block is a product of said attach rate of said building block entry and a planned volume for said time period associated with said volume data field for said configure-to-order product associated with said building block entry.

24. A method for determining a net demand volume of component parts to be ordered to build a planned volume of each product within a plurality of products and for each time period within a plurality of time periods, wherein said method comprises performing the following steps for each time period within said plurality of time periods:
(a) determining whether a volume of component parts on order is greater than a volume of component parts required to build said planned volume of said product,
(b) in response to a determination in step (a) that said volume of component parts on order is less than said volume of component parts required to build said planned volume of said product, setting a net demand variable to a difference between said volume of component parts required to build said planned volume of said product and said volume of component parts on order to a data structure,
(c) in response to a determination in step (a) that said volume of component parts on order is greater than said volume of component parts required to build said planned volume of said product, setting said net demand variable to a value of zero and determining whether a first flag is set to configure said method,
(d) in response to a determination in step (c) that said first flag is set, setting a planning volume variable to a volume equal to said volume of component parts on order to said data structure, and
(e) in response to a determination in step (c) that said first flag is not set, setting a planning volume variable to said volume of component parts required to build said planned volume of said product to said data structure.

25. The method of claim 24, wherein
step (a) is preceded by:
reading said volume of component parts on order from an entry within a supplier order log data structure, and
reading said planned volume of said product from an entry within a demand data structure; and
steps (b), (d), and (e) are each followed by:
writing said net demand variable to a net demand data structure within a field representing said time period and within an entry representing said product, and
writing said planning volume variable to a demand data structure within a field representing said time period and within an entry representing said product.

26. A method for determining a net demand volume of component parts to be ordered to build a planned volume of each configure-to-order product within a plurality of configure to order products and for each time period within a plurality of time periods, wherein
said component parts to build each said configure-to-order product are described within entries within a plurality of building block data structures,
each of said building block data structures is associated with an attach rate representing a planned portion of said configure-to-order products including component parts described in said building block data structure identified within said building block entry, and
said method comprises, for each time period within a plurality of time periods, for each configure-to-order product within said plurality of configure to order products, and for each building block data structure describing component parts
(a) determining whether a second flag is set to configure said method,
(b) in response to a determination in step (a) that said second flag has not been set, setting a volume of component parts described in said building block data structure for all of said configure-to-order product to be built during said time period to a level holding said attach rate associated with said building block data structure at a planned level of said attach rate,
(c) in response to a determination in step (a) that said second flag has been set, setting said volume of component parts described in said building block data structure to a sum of a first level determined by existing customer orders for said configure-to-order product having said component parts described in said building block data structure and a second level determined by applying said planned level of said attach rate associated with said building block data structure to a portion of a planned volume of said configure-to-order product for which customer orders have not been received,
(d) determining whether a volume of said component parts described in said building block data structure on order is greater than said volume of component parts described in said building block set in steps (b) and (c),
(e) in response to determining in step (d) that said volume of said component parts described in said building block data structure on order is not greater than said volume of component parts described in said building block set in steps (b) and (c), setting a net demand volume variable to a difference between said volume of component parts described in said building block set in steps (b) and (c),
(f) in response to determining in step (d) that said volume of component parts described in said building block data structure on order is greater than said volume of component parts described in said building block set in steps (b) and (c), setting said net demand volume variable to a level of zero and determining whether a first flag is set to configure said method,
(g) in response to determining in step (f) that said first flag is set, setting a planning volume variable to a volume equal to said volume of said component parts described in said building block data structure on order, and
(h) in response to determining in step (f) that said first flag is not set, setting said planning volume variable to a volume equal to said volume of component parts described in said building block set in steps (b) and (c),

27. The method of claim 26, wherein
step (b) is preceded by:
reading said volume of component parts described in said building block data structure on order from an entry within a supplier order log data structure, and
reading said planned volume of said component parts described in said building block data structure from an entry within a demand data structure;
step (e) is followed by writing said net demand variable to a net demand data structure within a field representing said time period and within an entry representing said building block data structure; and
steps (g), and (h) are each followed by:
writing said net demand variable to a net demand data structure within a field representing said time period and within an entry representing said building block data structure, and
writing said planning volume variable to a demand data structure within a field representing said time period and within an entry representing said building block data structure.

28. A method for determining volumes of groups of component parts to order within constraints of a planned demand for products built with said component parts and within constraints of an available supply of said component parts, during a plurality of time periods, wherein said method comprises:
(a) for each time period within said plurality of time periods, and for each of said groups, determining a supplier of each component part, and for each supplier of component parts within said groups of component parts, generating a parts demand data structure describing each of said component parts supplied by said supplier in a volume required to meet said planned demand for products built with said component parts;
(b) transmitting data from said parts demand data structure for each said supplier to said supplier;
(c) for each said supplier, receiving data describing a volume of said component parts described within said data from said parts demand data structure that can be supplied during said each said time period, and writing said data received from said supplier to a committed parts data structure; and
(d) for each of said component parts, determinating a cumulative supply volume from said data received from said suppliers and a cumulative demand volume from said planned demand for products built with said component parts for each time period within said plurality of time periods;
(e) for each of said groups, and for each time period within said plurality of time periods, determining a maximum volume of said group that can be built within said time period, wherein a volume of each component part in said maximum volume of said group is not greater than said cumulative supply volume of said component part, and wherein said volume of each component part in said maximum volume of said group is not greater than said cumulative demand volume of said component part, and writing said maximum volume of each said group to a committed group volumes data structure.

29. The method of claim 28, wherein, for each said time period and for each of said groups, step (a) includes:
reading an entry within a net demand data structure identifying a net volume and a bill of materials listing component parts within said group; and
for each entry in said bill of materials, performing the following steps (f) through (h):
(f) multiplying a quantity of a component identified in said entry of said bill of materials by said net volume from said net demand data structure to determine a demand volume of said component;
(g) determining a supplier of said component; and
(h) writing an entry identifying said component and said demand volume to a parts demand data structure associated with said supplier.

30. The method of claim 28, wherein
step (b) includes transmitting said data from said parts demand data structure to a computer system of said supplier over a computer network, and
step (c) includes receiving said data describing a volume of said component parts from said supplier over said computer network.

31. The method of claim 28, wherein step (d) includes:
for each entry within a net demand data structure identifying a net volume of a group and a bill of materials data structure listing component parts for said group, reading said entry and finding said bill of materials data structure identified within said entry; and
for each entry within said bill of materials data structure, performing the following steps (i) through (k):
(i) reading a supply volume for a component part identified within said entry, received from said supplier of said component part and written to said committed parts data structure in step (c);
(j) reading a demand volume for said component part from said net demand data structure;
(k) for each time period within said plurality of time periods, generating a cumulative supply volume as a sum of said supply volume for said time period and of each supply volume for a period within said plurality of time periods preceding said time period, generating a cumulative demand volume as a sum of said demand volume for said time period and of each demand volume for a period within said plurality of time periods preceding said time period, writing said cumulative supply volume to a cumulative supply by parts data structure, and writing said cumulative demand volume to a cumulative demand by parts data structure.

32. The method of claim 28, wherein step (e) includes:
for each time period within said plurality of time periods, with said time periods being considered in sequential order, and for each entry within a net demand data structure identifying a net volume of a group and a bill of materials data structure listing component parts for said group, reading said entry and finding said bill of materials data structure identified within said entry; and
for each entry within said bill of materials data structure, performing the following steps (I) through (n):
(l) calculating a first maximum volume of a group including said cumulative supply volume of a component part identified in said entry within said bill of materials data structure;
(m) calculating a second maximum volume of said group including said cumulative demand volume of said component part identified in said entry within said bill of materials data structure; and
(n) determining a volume of said group constrained by said component part as a lower value of said first and second maximum volumes;
determining a maximum constrained volume of said group as a minimum of said volumes of said group constrained by each component part within said bill of materials data structure listing component parts for said group;
writing said maximum constrained volume of said group to a committed volumes data structure; and
reducing said cumulative supply and demand volumes for each time period in said plurality of time periods following said time period being considered, and for each component part within said group by said volume of component parts within said maximum constrained volume of said group.

33. The method of claim 28, wherein
said products include a plurality of fixed configuration products, and
each of said fixed configuration products includes component parts described in a group within said groups of component parts.

34. The method of claim 28, wherein
said products include a plurality of configure-to-order products,
each of said configure-to-order products includes component parts described in a plurality of building block data structures, and
each of said building block data structures includes component parts described in a group within said groups of component parts.

35. The method of claim 34, wherein step (e) is followed by the following steps (o) and (p):
(o) for each of said groups including blocks described in a building block data structure, determinating a cumulative supply volume from said committed group volume data structure and a cumulative demand volume from said planned demand for products built with said component parts from said building block data structures, for each time period within said plurality of time periods;
(p) for each of said configure-to-order products, and for each time period within said plurality of time periods, determining a maximum volume of said configure-to-order product that can be built within said time period, wherein a volume of component parts in each said building block data structure within said configure to order product is not greater than said cumulative supply volume of component parts described within said building block data structure, and wherein said volume of each component part in said configure-to-order product is not greater than said cumulative demand volume of said component parts within said building block data structure, and writing said maximum volume of each said configure-to-order product to a committed product volumes data structure.

36. The method of claim 35, wherein step (o) includes:
for each entry within a net demand data structure identifying a net volume of a group including components included within a building block data structure within said plurality of building block data structures and a bill of materials data structure listing component parts for said group, performing the following steps:
(i) reading a supply volume for said group from a committed volumes data structure;
(j) reading a demand volume for said group from said net demand data structure;
(k) for each time period within said plurality of time periods, generating a cumulative supply volume as a sum of said supply volume for said time period and of each supply volume for a period within said plurality of time periods preceding said time period, generating a cumulative demand volume as a sum of said demand volume for said time period and of each demand volume for a period within said plurality of time periods preceding said time period, writing said cumulative supply volume to a cumulative supply by group data structure, and writing said cumulative demand volume to a cumulative demand by group data structure.

37. The method of claim 35, wherein step (p) includes:
for each time period within said plurality of time periods, with said time periods being considered in sequential order, and for each entry within a net demand data structure identifying a net volume of a group including components included within a building block data structure within said plurality of said building block data structures, performing the following steps:
(l) calculating a first maximum volume of a configure-to-order product including a cumulative supply volume of said group;
(m) calculating a second maximum volume of said configure-to-order product including said cumulative demand volume of said group;
(n) determining a volume of said configure-to-order product constrained by said group as a lower value of said first and second maximum volumes;
determining a maximum constrained volume of said configure-to-order product as a minimum of said volumes of said configure-to-order product constrained by each of said groups;
writing said maximum constrained volume of said group to a committed product volumes data structure; and
reducing said cumulative supply and demand volumes for each time period in said plurality of time periods following said time period being considered, and for each said group including components described within a building block data structure by said volume of said group within said maximum constrained volume of said configure-to-order product.

38. A method for planning ordering of component parts for products within a plurality of products over a number of time periods in accordance with customer orders for said products, wherein
said method comprises sequentially performing a planning process during sequentially occurring time periods,
said planning process is performed for a plurality of time periods, and
said planning process includes:
determining demand volumes of groups of said component parts needed for planning volumes of said products in each time period within said plurality of time periods;
determining net volumes of said groups of said component parts by subtracting volumes of said groups on order from said demand volumes;
deriving volumes of said component parts from said net volumes of said groups;
transmitting volumes of said component parts to suppliers of said component parts;
receiving committed volumes of said component parts from said suppliers of said component parts;
deriving committed volumes of said groups of said component parts from said committed volumes of said committed parts;
deriving committed volumes of said products from said committed volumes of said groups;
receiving orders from customers for said products;
deriving committed customer ordered volumes of said products from orders from customers for volumes of said products within said committed volumes of said products;
transmitting committed status information to said customers in response to deriving committed customer ordered volumes of said products, and
ordering volumes of said component parts from said suppliers.

39. The method of claim 38, wherein
said products include fixed configuration products and configure-to-order products,
said groups of component parts include product groups including component parts for said fixed configuration products and building blocks including portions of component parts for said configure-to-order products, and
said orders from customers include configuration specifications of said configure-to-order products.

40. The method of claim 39, additionally comprising:
receiving an input through a user interface modifying said planning volumes of said products, and
receiving an input through a user interface modifying volumes of said component parts ordered from said suppliers.
